(19) United States
(12) Patent Application Publication
(10) Pub. No.: US 2026/0278734 A1
(43) Pub. Date: Sep. 17, 2026

(54) ELECTRONIC DEVICE AND OPERATING METHOD OF THE SAME

(71) Applicant: Samsung Electronics Co., Ltd., Suwon-si (KR)

(72) Inventor: Hyukjoong KWON, Suwon-si (KR)

(21) Appl. No.: 19/679,418

(22) Filed: May 15, 2026

Related U.S. Application Data
(63) Continuation of application No. PCT/KR2025/019083, filed on Nov. 18, 2025.

(30) Foreign Application Priority Data
Nov. 19, 2024 (KR) 10-2024-0165626

(51) Int. Cl. G06T 3/4007; G09G 3/3208

(52) U.S. Cl. CPC G06T 3/4007; G09G 3/3208; G09G 2320/0257; G09G 2320/046; G09G 2340/045

(57) ABSTRACT

An electronic device includes a display, memory storing a program or at least one instruction, and at least one processor, including processing circuitry, wherein at least one processor individually or collectively is configured to execute the program or the at least one instruction stored in the memory and to cause the electronic device to obtain an input image, obtain a first output image by performing scaling on the input image using first interpolation, obtain a second output image by performing scaling on the input image using second interpolation different from the first interpolation, and display, through the display, the first output image in at least one first frame from among a plurality of output frames and the second output image in at least one second frame, the second frame being a remaining frame.

### CROSS-REFERENCE TO RELATED APPLICATIONS

This application is a continuation of International Application No. PCT/KR2025/019083 designating the United States, filed on November 18, 2025, in the Korean Intellectual Property Receiving Office and claiming priority to Korean Patent Application No. 10-2024-0165626, filed on November 19, 2024, in the Korean Intellectual Property Receiving Office, the disclosures of each of which are incorporated by reference herein in their entireties.

### BACKGROUND

### Field

The disclosure relates to an electronic device and an operating method of the electronic device. For example, the disclosure relates to an electronic device for generating an output image by performing scaling on an input image and an operating method of the electronic device.

### Description of Related Art

Recently, with developments in display technologies, techniques for displaying an image through an electronic device including various types of displays have been widely used.

For example, with developments in techniques of organic light-emitting diodes (OLEDs), the range of use of electronic devices displaying an image using displays including OLEDs has been increased.

However, due to characteristics of the OLED, when the OLED is used for a long period of time, the lifespan of the OLED may expire, and the problem of OLED burn-in may occur. Thus, an afterimage of an image may be left on a display, or a color of the image displayed may be distorted.

Therefore, techniques for an electronic device to display a protection image for protecting an OLED or to shift a position of an image displayed on a display, when a user input, etc. are not provided to the electronic device for a certain period of time, have been developed.

### SUMMARY

According to an example embodiment of the disclosure, an electronic device is provided. The electronic device may include: a display; memory storing a program or at least one instruction; at least one processor, comprising processor circuitry, wherein at least one processor, individually or collectively, may be configured to execute the program or the at least one instruction stored in the memory and to cause the electronic device to: obtain an input image; obtain a first output image by performing scaling on the input image using first interpolation; obtain a second output image by performing scaling on the input image using second interpolation different from the first interpolation; and display, through the display, the first output image in at least one first frame from among a plurality of output frames and the second output image in at least one second frame, the second frame being a remaining frame.

According to an example embodiment of the disclosure, a method of operating the electronic device is provided. The method of operating the electronic device may include: obtaining an input image; obtaining a first output image by performing scaling on the input image using first interpolation; obtaining a second output image by performing scaling on the input image using second interpolation different from the first interpolation; and displaying, through a display, the first output image in at least one first frame from among a plurality of output frames and the second output image in at least one second frame, the second frame being a remaining frame.

According to an example embodiment of the disclosure, a non-transitory computer-readable recording medium having recorded thereon a program which, when executed by at least one processor, comprising processing circuitry, individually and/or collectively, of an electronic device, causes the electronic device to perform at least one method of the method of operating the electronic device, is provided.

The technical problem to be addressed in this disclosure is not limited to the technical problem described above, and other technical problems not described may be clearly understood by one of ordinary skill in the art from the description below.

### BRIEF DESCRIPTION OF THE DRAWINGS

The disclosure shall be understood through the detailed descriptions below and the accompanying drawings, and reference numerals denote structural elements. Further, the above and other aspects, features and advantages of certain embodiments of the present disclosure will be more apparent from the following detailed description, taken in conjunction with the accompanying drawings, in which:

FIG. 1 is a diagram illustrating an example operation of an electronic device according to various embodiments;

FIG. 2 is a block diagram illustrating an example configuration of an electronic device according to various embodiments;

FIG. 3 is a flowchart illustrating an example operation of an electronic device, according to various embodiments;

FIG. 4 is a diagram illustrating an example operation of performing scaling in order to adjust a size of an image, according to various embodiments;

FIG. 5 is a diagram illustrating a difference between different output images obtained by performing scaling using different interpolation methods, according to various embodiments;

FIG. 6 is a flowchart illustrating an example operation of correcting a second output image, such that gradation information of a pixel included in a first output image becomes different from gradation information of a pixel included in the second output image, according to various embodiments;

FIG. 7 is a flowchart illustrating an example operation of correcting a second output image, such that a maximum luminance of a first output image becomes different from a maximum luminance of the second output image, according to various embodiments;

FIG. 8 is a flowchart illustrating an example operation of setting a period of at least one second frame in a plurality of output frames, according to various embodiments;

FIG. 9 is a diagram illustrating an example operation of displaying a first output image in at least one first frame from among a plurality of output frames and a second output image in at least one second frame, which is a remaining frame, according to various embodiments;

FIG. 10 is a diagram illustrating an example operation of displaying a first output image in at least one first frame from among a plurality of output frames and a second output image in at least one second frame, which is a remaining frame, according to various embodiments;

FIG. 11 is a block diagram illustrating an example operation of obtaining different output images using a plurality of scalers configured to perform different interpolation methods, according to various embodiments;

FIG. 12 is a block diagram illustrating an example operation of obtaining different output images using an interpolation model included in a memory and a scaler configured to perform a different interpolation method from the interpolation model included in the memory, according to various embodiments;

FIG. 13 is a diagram illustrating an example operation of generating an output image including each of a plurality of correction frames using different interpolation methods for providing an image at a different frequency from an input image, according to various embodiments; and

FIG. 14 is a flowchart illustrating an example operation of generating an output image including each of a plurality of correction frames using different interpolation methods for providing an image at a different frequency from an input image, according to various embodiments.

### DETAILED DESCRIPTION

The terms used in the disclosure will be briefly described, and various example embodiments of the disclosure will be described in greater detail.

Throughout the disclosure, unless there is a particularly contrary description, "or" denotes an inclusive meaning, rather than an exclusive meaning. Thus, unless apparently otherwise shown or differently illustrated on the context, "A or B" may indicate "A," "B," or "both of A and B."

Throughout the disclosure, the expression "at least one of a, b or c" may indicate "a," "b," "c," "a and b," "a and c," "b and c," "all of a, b, and c," or variations thereof.

The terms used in the disclosure are general terms as possible that have been widely used nowadays in consideration of the functions in the disclosure, which, however, may be changed according to an intention of a technician in the art, a precedent, the advent of new technologies, or the like. In particular cases may include arbitrarily selected terms, and in this case, the meaning of the terms will be described in detail in the corresponding description. Therefore, the terms used in the disclosure should be defined based on the meanings of the terms and the content throughout the disclosure, rather than simply based on the titles of the terms.

A singular expression may include a plural expression, unless an apparently different meaning is indicated in the context. The terms used herein including technical or scientific ones may have meanings that are the same as the meanings generally understood by one of ordinary skill in the art described in this disclosure.

Throughout the disclosure, when a part "includes" or "comprises" an element, the part may further include other elements, not excluding the other elements, unless there is a particular description contrary thereto. Terms such as "unit," "module," etc. used in the disclosure should be understood as a unit that processes at least one function or operation and that may be embodied in a hardware manner, a software manner, or a combination of the hardware manner and the software manner.

The expression used in the disclosure "configured (or set) to" may be, depending on situations, interchangeably used, for example, with "suitable for," "having the capacity to," "designed to," "adapted to," "made to," or "capable of." The term "configured (or set) to" may not necessarily denote "specifically designed to" in a hardware manner. Rather, in a certain situation, the expression "a system configured to" may denote that a system is "capable of something" along with other devices or components. For example, "a processor configured (or set) to perform A, B, and C" may denote a dedicated processor (e.g., an embedded processor) for performing a corresponding operation or a general-purpose processor (e.g., a central processing unit (CPU) or an application processor) capable of performing corresponding operations by executing one or more software programs stored in a memory.

When it is described that a component is "connected to" or "in contact with" another component, etc., the component may be directly connected to or directly in contact with the other component, but unless particularly otherwise described, it shall also be understood that the component may be connected to or in contact with the other component with other components therebetween.

Combinations of blocks in each of flowcharts and the flowcharts shall be understood to be performed by one or more computer programs including computer-executable instructions. All of the one or more computer programs may be stored in a single memory or may be separately stored in a plurality of different memories.

All functions or operations described in this disclosure may be processed by one processor or a combination of a plurality of processors.

Functions related to artificial intelligence (AI) according to the disclosure may be operated through the processor and the memory. One or more processors may control processing of input data, according to a pre-defined operation rule or an AI model stored in a memory. When one or more processors are AI-dedicated processors, the AI-dedicated processors may be designed as a hardware structure specialized for processing a specific AI model.

The pre-defined operation rule or the AI model may be generated through training. To be generated through training may denote that a basic AI model is trained by a learning algorithm using a plurality of pieces of training data to generate the pre-defined operation rule or the AI model configured to perform a desired feature (or purpose). The training may be performed by an electronic device itself using an AI model according to the disclosure or may be performed by an additional server and/or system. Examples of the learning algorithm may include, but is not limited to, supervised learning, unsupervised learning, semi-supervised learning, or reinforcement learning.

The AI model may include a plurality of neural network layers. The plurality of neural network layers may respectively have a plurality of weight values and may perform calculation using a calculation result of a previous layer and calculation between the plurality of weight values. The plurality of weight values of the plurality of neural network layers may be optimized by a training result of the AI model. For example, the plurality of weight values may be modified and refined to reduce or minimize a loss value or a cost value obtained from the AI model during a training process. The AI neural network may include, for example, and without limitation, a deep neural network (DNN), a convolutional neural network (CNN), a recurrent neural network (RNN), a restricted Boltzmann machine (RBM), a deep belief network (DBN), a bidirectional recurrent deep neural network (BRDNN), and/or a deep Q-network, but is not limited thereto.

Hereinafter, various example embodiments of the disclosure will be described in greater detail with reference to the accompanying drawings. However, various embodiments of the disclosure may have different forms and should not be construed as being limited. In the drawings, parts not related to descriptions are omitted for the clear description of an embodiment of the disclosure, and throughout the disclosure, like reference numerals are used for like elements.

Hereinafter, various example embodiments of the disclosure are described in greater detail with reference to the drawings.

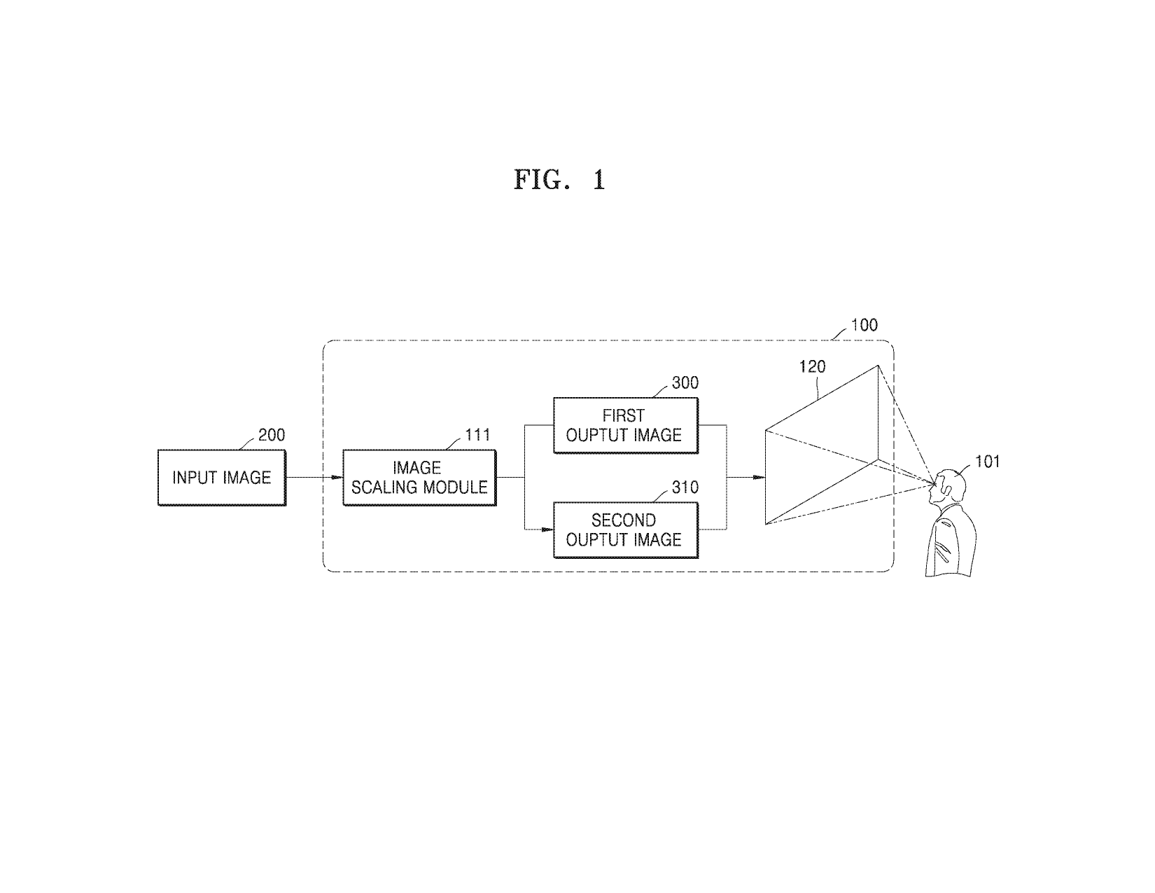

FIG. 1 is a diagram illustrating an example operation of an electronic device 100 according to various embodiments.

Referring to FIG. 1, according to an embodiment of the disclosure, the electronic device 100 may obtain an input image 200 and may display and provide, to a user 101, an output image based on the input image 200. The electronic device 100 may include a display 120 and may display and provide, to the user 101, the output image through the display 120.

According to an embodiment of the disclosure, the electronic device 100 may be realized in various shapes, such as, for example, and without limitation, a television, a mobile device, a smartphone, a laptop computer, a desktop computer, a tablet personal computer (PC), a digital signage, a projector, a wearable device, or the like.

According to an embodiment of the disclosure, the input image 200 may include content including color information, such as red, green, and blue. The input image 200 may include a plurality of images respectively corresponding to a plurality of input frames. The input image 200 may include a still image or a motion image and is not limited to either one.

According to an embodiment of the disclosure, a resolution of the input image 200 obtained by the electronic device 100 may be different from a resolution of the output image intended to be displayed through the display 120. As the resolution of the output image and the resolution of the input image 200 are different from each other, the electronic device 100 may obtain the output image by scaling the input image 200. According to an embodiment of the disclosure, the electronic device 100 may perform scaling on the input image 200 using interpolation.

For example, when the resolution of the output image is greater than the resolution of the input image 200, the electronic device 100 may obtain the output image having the greater resolution through upscaling of the input image 200. When the resolution of the output image is less than the resolution of the input image 200, the electronic device 100 may obtain the output image having the less resolution through downscaling of the input image 200.

According to an embodiment of the disclosure, the resolution of the output image may be changed by adjusting an area of the display 120, on which the output image is displayed. In detail, the resolution of the output image displayed on the display area may be reduced by adjusting the display area, on which the output image is displayed, to have a reduced size in the display 120. The resolution of the output image displayed on the display area may be increased by adjusting the display area, on which the output image is displayed, to have an increased size in the display 120. Regardless of the size of the display area, the output image displayed on the display area may contain the same content.

The electronic device 100 may obtain the output image having the adjusted resolution through scaling on the input image 200.

According to an embodiment of the disclosure, the display 120 included in the electronic device 100 may include a plurality of organic light-emitting diodes (OLEDs). However, the disclosure is not limited thereto, and the electronic device 100 may include light sources, such as various types of light-emitting devices capable of displaying an output image. Hereinafter, for convenience of explanation, an organic light-emitting diode included in the display 120 is referred to as an OLED.

According to an embodiment of the disclosure, when the same image is displayed by the plurality of OLEDs for a long period of time, the lifespan of the OLEDs may be reduced due to the characteristics of the devices. Also, each of the OLEDs emitting light of different wavelengths may have a different lifespan.

Thus, when a display including a plurality of OLEDs is used for a long period of time, a problem caused by burn-in of the plurality of OLEDs may occur, such as the remaining of an afterimage of an image displayed in a previous frame in a current frame, a change of color in an image, or the like.

According to an embodiment of the disclosure, according to a type of interpolation used to perform scaling on the input image 200, an obtained output image may vary. The electronic device 100 may obtain a plurality of different output images by performing scaling on the input image 200 using different interpolations. Gradation information of at least one of red, green, or blue of any one first pixel included in any one output image from among the plurality of output images may be different from gradation information of at least one of red, green, or blue included in a second pixel included in another output image, the second pixel corresponding to the first pixel.

According to an embodiment of the disclosure, the electronic device 100 may perform scaling on the input image 200 through an image scaling module (e.g., including various circuitry and/or executable program instructions, including various models) 111. The image scaling module 111 may include different interpolation models. According to an embodiment of the disclosure, the image scaling module 111 may include a first interpolation model and a second interpolation model. The first interpolation model may include an algorithm for performing a first interpolation method, and the second interpolation model may include an algorithm for performing a second interpolation method different from the first interpolation method.

According to an embodiment of the disclosure, the electronic device 100 may obtain a first output image 300 and a second output image 310 by performing scaling on the input image 200 using the image scaling module 111. The first output image 300 may be obtained by performing scaling on the input image 200 using the first interpolation model. The second output image 310 may be obtained by performing scaling on the input image 200 using the second interpolation model.

According to an embodiment of the disclosure, the electronic device 100 may display the output image through the display 120 during a plurality of output frames. The "plurality of output frames" may denote frames in which the electronic device 100 displays an image on the display 120 for one second according to a driving frequency at which the display 120 is driven. According to an embodiment of the disclosure, as the electronic device 100 drives the display 120 at 60 hertz (Hz), the plurality of output frames may denote 60 frames.

According to an embodiment of the disclosure, the electronic device 100 may display the first output image 300 in at least one first frame from among the plurality of output frames. The electronic device 100 may display the second output image 310 in at least one second frame, which is a remaining frame from among the plurality of output frames.

According to an embodiment of the disclosure, as the electronic device 100 displays the first output image 300 in the first frame and the second output image 310 in the second frame from among the plurality of output frames, gradation information of at least one of red, green, or blue displayed through the plurality of OLEDs included in the display 120 may be changed during the plurality of output frames. Thus, a driving voltage applied to each of the plurality of OLEDs in the plurality of output frames may be changed, and thus, the lifespans of the plurality of OLEDs may be improved.

According to an embodiment of the disclosure, as the lifespans of the plurality of OLEDs included in the display 120 are improved, it is possible to prevent and/or reduce a problem caused by burn-in of the plurality of OLEDs, such as the remaining of an afterimage of an output image displayed in a previous frame in a current frame, a change of color of an image, or the like.

The first output image 300 obtained using the first interpolation model and the second output image 310 obtained using the second interpolation model, the first interpolation model and the second interpolation model being different from each other, may be obtained based on the same input image 200, and thus, the difference between the first output image 300 and the second output image 310 may not be great. Thus, the user 101 viewing, through the display 120, the first output image 300 provided in the first frame and the second output image 310 provided in the second frame, may not see or perceive the difference between the first output image 300 and the second output image 310.

The disclosure is not limited thereto, and a frequency of the output image displayed through the display 120 may be different from a frequency of the input image 200. According to an embodiment of the disclosure, the input image 200 may include a plurality of input frames, and the output image may be displayed throughout a plurality of output frames. As the frequency of the input image 200 is different from the frequency of the output image, the number of input frames may be different from the number of output frames. As the frequency of the output image is different from the frequency of the input image 200, the electronic device 100 may obtain the output image by scaling the input image 200 using interpolation.

For example, as the frequency of the output image is higher than the frequency of the input image 200, the electronic device 100 may scale the input image 200 generate the output image corresponding to a plurality of correction frames. The electronic device 100 may display the input image 200 in the plurality of input frames and the output image in the plurality of correction frames from among the plurality of output frames.

According to an embodiment of the disclosure, the electronic device 100 may scale the input image 200 using different interpolations and may thus obtain a third output image corresponding to a plurality of first correction frames and a fourth output image corresponding to a plurality of second correction frames.

According to an embodiment of the disclosure, the electronic device 100 may display, through the display 120, the input image 200 in the plurality of input frames, the third output image in the plurality of first correction frames, and the fourth output image in the plurality of second correction frames, from among the plurality of output frames.

Thus, the electronic device 100 according to the disclosure may prevent and/or reduce the problem caused by burn-in of a plurality of OLEDs included in the display 120, while making the difference in the output image displayed through the display 120 unnoticeable to the user 101.

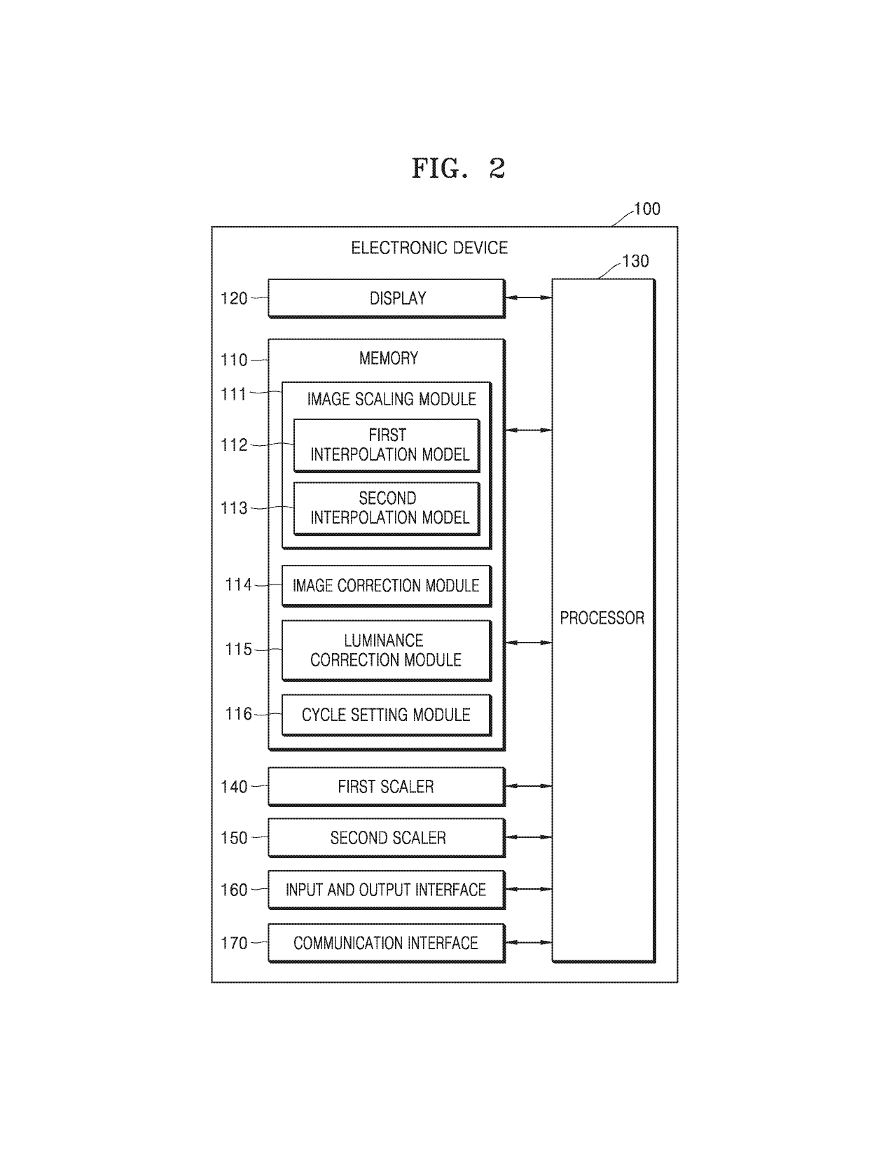

Hereinafter, example components and an operating method of the electronic device 100 according to the disclosure will be described in greater detail below with reference to FIGS. 2 to 14.

FIG. 2 is a block diagram illustrating an example configuration of the electronic device 100 according to various embodiments.

Referring to FIGS. 1 and 2, according to an embodiment of the disclosure, the electronic device 100 may include the display 120, a memory 110, at least one processor (e.g., including processing circuitry) 130, a first scaler (e.g., including various circuitry and/or executable program instructions) 140, a second scaler (e.g., including various circuitry and/or executable program instructions) 150, an input and output interface (e.g., including circuitry) 160, and a communication interface (e.g., including communication circuitry) 170.

However, not all of the components illustrated in FIG. 2 are essential components. The electronic device 100 may also be realized by including more components or less components than the components illustrated in FIG. 2.

Each of the display 120, the memory 110, the at least one processor 130, the first scaler 140, the second scaler 150, the input and output interface 160, and the communication interface 170 included in the electronic device 100 may be electrically connected to each other.

According to an embodiment of the disclosure, the display 120 may include an OLED. However, the disclosure is not limited thereto, and the display 120 may include a light-emitting device, such as an inorganic light-emitting diode, a liquid crystal display, or a plasma display. The electronic device 100 may obtain an output image by scaling the input image 200 and may thus perform the various operations of the disclosure.

According to an embodiment of the disclosure, instructions, a data structure, and a program code which may be read by the at least one processor 130 may be stored in the memory 110. According to an embodiment of the disclosure, there may be one or more memories 110. Operations performed by the electronic device 100 may be realized by the at least one processor 130 executing the instructions or codes of a program stored in the memory 110.

According to an embodiment of the disclosure, the memory 110 may include at least one of a flash memory type, a hard disk type, a multimedia card micro type, a card-type memory (for example, an SD memory or an XD memory), random-access memory (RAM), static RAM (SRAM), read-only memory (ROM), electrically erasable programmable ROM (EEPROM), programmable ROM (PROM), mask ROM, flash ROM, a hard disk drive (HDD), or a solid state drive (SSD).

According to an embodiment of the disclosure, the memory 110 may be included in the at least one processor 130, rather than being additionally provided.

According to an embodiment of the disclosure, instructions or a program code for performing a function or operations of the electronic device 100 may be stored in the memory 110. The instructions, algorithms, data structures, program codes, and application programs stored in the memory 110 may be realized as a programming or scripting language such as C, C++, Java, python, assembler, etc.

According to an embodiment of the disclosure, the memory 110 may store various types of modules which may be used to perform the operations of the electronic device 100.

According to an embodiment of the disclosure, the memory 110 may store the image scaling module 111, an image correction module 114, a luminance correction module 115, and a period setting module 116. However, not all of the modules illustrated in FIG. 2 are essential. The memory 110 may store more modules or less modules than the modules illustrated in FIG. 2.

According to an embodiment of the disclosure, each "module" included in the memory 110 may denote a unit configured to process a function or an operation performed by the at least one processor 130. The "module" included in the memory 110 may be realized as software, such as instructions, algorithms, data structures, or program codes.

According to an embodiment of the disclosure, the image scaling module 111 may include instructions or program codes related to an operation or a function of performing scaling on the input image 200 and obtaining an output image having a resolution different from a resolution of the input image 200. According to an embodiment of the disclosure, an interpolation algorithm included in the image scaling module 111 may include nearest neighbor interpolation, bilinear interpolation, bicubic interpolation, etc., but is not limited thereto.

According to an embodiment of the disclosure, the image scaling module 111 may include a first interpolation model 112 and a second interpolation model 113. The first interpolation model 112 may include an interpolation algorithm of any one of the nearest neighbor interpolation, the bilinear interpolation, or the bicubic interpolation. The second interpolation model 113 may include an interpolation algorithm different from the interpolation algorithm included in the first interpolation model 112 from among the nearest neighbor interpolation, the bilinear interpolation, or the bicubic interpolation.

However, the disclosure is not limited thereto, and the image scaling module 111 may also include various interpolation algorithms which may be used to obtain an output image having a different resolution from the input image 200. The interpolation algorithm included in each of the first interpolation model 112 and the second interpolation model 113 may just be different from each other and is not limited to any one interpolation algorithm.

According to an embodiment of the disclosure, the second interpolation model 113 may further include an algorithm pre-set to scale at least one pixel including pre-set first gradation information included in the input image 200 to at least one pixel including second gradation information set to be different from the first gradation information.

According to an embodiment of the disclosure, the at least one processor 130 may include various processing circuitry and execute the instructions or program codes of the image scaling module 111 to cause the electronic device 100 to perform scaling on the input image 200 to obtain an output image.

According to an embodiment of the disclosure, the at least one processor 130 may execute the instructions or program codes of the image scaling module 111 to cause the electronic device 100 to obtain the first output image 300 by performing, using the first interpolation model 112, scaling on the input image 200. The at least one processor 130 may execute the instructions or program codes of the image scaling module 111 to cause the electronic device 100 to obtain the second output image 310 by performing, using the second interpolation model 113, scaling on the input image 200.

However, the disclosure is not limited thereto. The image scaling module 111 may include instructions or program codes related to an operation or function of obtaining, based on the input image 200, an output image corresponding to a correction frame, in order to display the output image by a frequency different from a frequency of the input image 200.

According to an embodiment of the disclosure, the interpolation algorithm included in the image scaling module 111 may include linear interpolation, motion compensation interpolation, frame blending, etc., but is not limited thereto. However, the disclosure is not limited thereto, and the image scaling module 111 may also include various interpolation algorithms which may be used to obtain an output image corresponding to a correction frame, based on the input image 200.

The image scaling module 111 may further include a third interpolation model including an interpolation algorithm from among linear interpolation, motion compensation interpolation, or frame blending. The image scaling module 111 may further include a fourth interpolation model including an interpolation algorithm different from the interpolation algorithm included in the third interpolation model from among linear interpolation, motion compensation interpolation, or frame blending.

The interpolation algorithm included in each of the third interpolation model and the fourth interpolation model may just be different from each other, but is not limited to any one interpolation algorithm.

According to an embodiment of the disclosure, the image scaling module 111 may include an AI model pre-trained to receive an input of the input image 200 and scale the input image 200 to infer at least one of the first output image 300 or the second output image 310. The AI model included in the image scaling module 111 may include a DNN and may include a layer configured to perform a convolution operation. The AI model included in the image scaling module 111 may include a CNN or a generative adversarial network (GAN), but the AI model in the disclosure is not limited to the example described above. At least one of the first interpolation model 112, the second interpolation model 113, the third interpolation model, or the fourth interpolation model may include a pre-trained AI model.

According to an embodiment of the disclosure, the image correction module 114 may include instructions or program codes related to an operation or function of obtaining a corrected output image by correcting gradation information of a pixel included in an image. In detail, the image correction module 114 may include instructions or program codes related to an operation or function of comparing the first output image 300 with the second output image 310 and changing gradation information of a corresponding pixel of the second output image 310 when it is identified that gradation information of any one pixel from among a plurality of pixels included in the first output image 300 is the same as the gradation information of any one pixel from among a plurality of pixels included in the second output image 310, the any one pixel corresponding to the any one pixel of the first output image 300.

According to an embodiment of the disclosure, the degree of correcting the gradation information of the pixel of the second output image 310 may be pre-set. According to an embodiment of the disclosure, the image correction module 114 may reduce gradation information of at least one pixel from among the plurality of pixels of the second output image 310, the at least one pixel having the same gradation information as a corresponding pixel of the first output image 300, by a pre-set first correction ratio.

According to an embodiment of the disclosure, the at least one processor 130 may execute the instructions or program codes of the image correction module 114 to cause the electronic device 100 to change the gradation information of the at least one pixel from among the plurality of pixels of the second output image 310, the at least one pixel having the same gradation information as the corresponding pixel of the first output image 300, to obtain a corrected output image.

According to an embodiment of the disclosure, the luminance correction module 115 may include instructions or program codes related to an operation or function of obtaining a corrected output image by correcting an image to have a different maximum luminance. In detail, the luminance correction module 115 may include instructions or program codes related to an operation or function of comparing the first output image 300 with the second output image 310 and changing the maximum luminance of the second output image 310 when it is identified that gradation information of any one pixel from among a plurality of pixels included in the first output image 300 is the same as gradation information of any one pixel from among a plurality of pixels included in the second output image 310, the any one pixel corresponding to the any one pixel of the first output image 300.

The "maximum luminance" may denote a luminance by which the maximum gradation information, which may be included in a pixel in a corresponding image, is displayed through the display 120. According to an embodiment of the disclosure, when the gradation information has values of 8 bits that are from 0 to 255, the maximum luminance may denote a luminance by which the display 120 displays a pixel, the luminance corresponding to the gradation information of the value of 255. For example, the maximum luminance may be the luminance of the display 120 displaying a corresponding pixel which includes white data in which the gradation information of all of red, green, and blue have the value of 255.

According to an embodiment of the disclosure, the at least one processor 130 may execute the instructions or program codes of the luminance correction module 115 to cause the electronic device 100 to obtain a corrected output image by correcting the second output image 310 to have a different maximum luminance from the first output image 300 when it is identified that gradation information of any one pixel from among a plurality of pixels of the second output image 310 is the same as gradation information of any one pixel included in the first output image 300, the any one pixel corresponding to the corresponding pixel included in the second output image 310.

According to an embodiment of the disclosure, the period setting module 116 may include instructions or program codes related to an operation or function of setting a period of the second frame in which the second output image 310 is displayed among the plurality of output frames of the output image displayed through the display 120.

According to an embodiment of the disclosure, the period setting module 116 may include instructions or program codes related to an operation or function of setting, based on the input image 200, a period of the second frame among the plurality of output frames. In detail, the period setting module 116 may include instructions or program codes related to an operation or function of setting the period of the second frame to decrease among the plurality of output frames when the input image 200 is a still image not changing during the plurality of frames or when the input image 200 includes an increased proportion of a certain color.

According to an embodiment of the disclosure, the at least one processor 130 may execute the instructions or program codes of the period setting module 116 to cause the electronic device 100 to differently set the period of the second frame among the plurality of output frames, based on the input image 200.

However, the disclosure is not limited thereto, and the period of the second frame among the plurality of output frames may be pre-set based on the characteristic of the display 120, for example, types or the characteristics of the plurality of OLEDs included in the display 120.

According to an embodiment of the disclosure, the at least one processor 130 may include one or more processors configured to control a series of processes for the electronic device 100 to operate, according to embodiments of the disclosure described hereinafter.

According to an embodiment of the disclosure, the at least one processor 130 may include at least one of a CPU, a microprocessor, a graphics processing unit (GPU), an application processor (AP), application specific integrated circuits (ASICs), digital signal processors (DSPs), digital signal processing devices (DSPDs), programmable logic devices (PLDs), field programmable gate arrays (FPGAs), a communication processor (CP), a neural processing unit, and/or an AI-dedicated processor configured to have a hardware structure specialized for training and processing of an AI model, but is not limited thereto. Thus, the at least one processor 130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

According to an embodiment of the disclosure, the at least one processor 130 may include circuitry, such as a system on chip (SoC) or an integrated circuit (IC). The at least one processor 130 may include a processing circuit.

According to an embodiment of the disclosure, the at least one processor 130 may execute various types of modules stored in the memory 110. The at least one processor 130 may individually or collectively execute at least one instruction included in various types of modules stored in the memory 110. The at least one processor 130 may execute the program or the at least one instruction stored in the memory 110 to process data according to a pre-defined operation rule.

According to an embodiment of the disclosure, the at least one processor 130 may include a plurality of processors. According to an embodiment of the disclosure, at least one module from among the plurality of modules stored in the memory 110 may be executed by any one of the plurality of processors. Remaining modules from among the plurality of modules stored in the memory 110 may be executed by other processors from among the plurality of processors.

According to an embodiment of the disclosure, the electronic device 100 may include a scaler designed as hardware using a hardware description language, for example, Verilog or a VHSIC hardware description language (VHDL), etc. for performing scaling on the input image 200. According to an embodiment of the disclosure, the scaler may be configured to perform an interpolation algorithm used for scaling the input image 200.

According to an embodiment of the disclosure, the electronic device 100 may include a first scaler 140 and a second scaler 150, each of which may include various circuitry and/or executable program instructions. The first scaler 140 may be configured to perform an operation of the first interpolation model 112. The second scaler 150 may be configured to perform an operation of the second interpolation model 113. However, the disclosure is not limited thereto, and each of the first scaler 140 and the second scaler 150 may be configured to perform an interpolation algorithm different from an interpolation algorithm included in the image scaling module 111.

According to an embodiment of the disclosure, the electronic device 100 may include an ASIC, an FPGA, or a hardware accelerator configured to include the first scaler 140 and the second scaler 150.

According to an embodiment of the disclosure, the at least one processor 130 may control operations of the first scaler 140 and the second scaler 150 for performing scaling on the input image 200.

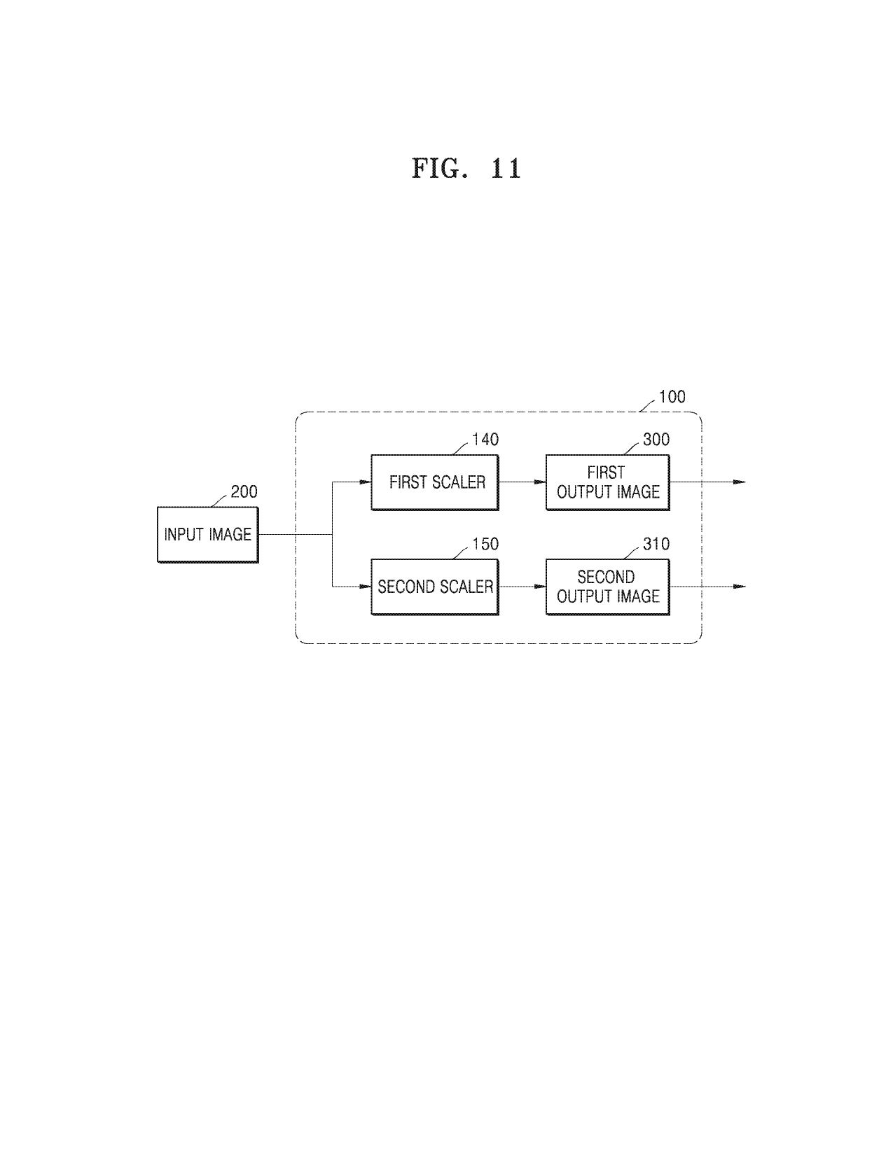

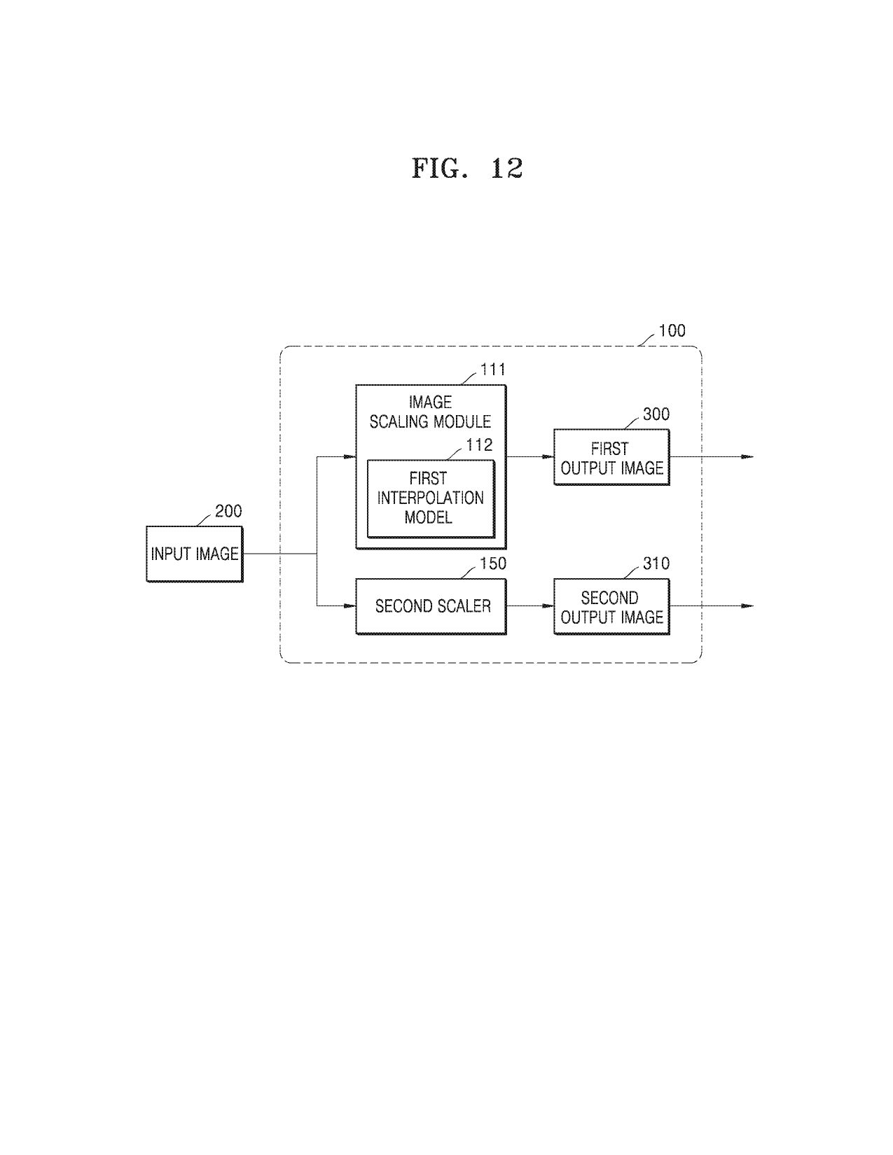

However, the disclosure is not limited thereto, and at least one of the first interpolation model 112, the second interpolation model 113, the first scaler 140, or the second scaler 150 included in the electronic device 100 illustrated in FIG. 2 may be omitted. Hereinafter, descriptions are given below with reference to FIGS. 11 and 12.

According to an embodiment of the disclosure, the at least one processor 130 may control the input and output interface 160 for the electronic device 100 to obtain the input image 200 from an external electronic device, etc. through the input and output interface 160.

The electronic device 100 may provide the first output image 300 and the second output image 310 to the external electronic device through the input and output interface 160.

According to an embodiment of the disclosure, the input and output interface 160 may include various circuitry and perform an input and output operation with the external electronic device by using at least one of input and output methods including a high-definition multimedia interface (HDMI) port, a digital visual interface (DVI), component jack, a PC port, or a universal serial bus (USB) port. However, the disclosure is not limited to the input and output methods described above.

According to an embodiment of the disclosure, the at least one processor 130 may control the communication interface 170 for the electronic device 100 to perform data communication with an external server or an external electronic device.

The communication interface 170 may include various communication circuitry and perform data communication with an external server or an external electronic device using at least one of data communication methods including, for example, a wired local area network (LAN), a wireless LAN, WiFi, Bluetooth, Zigbee, WiFi direct (WFD), infrared data association (IrDA), Bluetooth low energy (BLE), near-field communication (NFC), wireless broadband Internet (Wibro), world interoperability for microwave access (WiMAX), a shared wireless access protocol (SWAP), wireless gigabit alliance (WiGig), and radio frequency (RF) communication.

The electronic device 100 may obtain the input image 200 from the external electronic device or the external server through the communication interface 170. The electronic device 100 may provide the first output image 300 and the second output image 310 to the external electronic device or the external server through the communication interface 170.

According to an embodiment of the disclosure, the electronic device 100 may obtain at least one of the first interpolation model 112, the second interpolation model 113, the image correction module 114, or the luminance correction module 115 from the external electronic device or the external server through the communication interface 170.

According to an embodiment of the disclosure, the electronic device 100 may obtain a pre-trained AI model included in at least one of the first interpolation model 112 or the second interpolation model 113 from the external server or the external electronic devices through the communication interface 170.

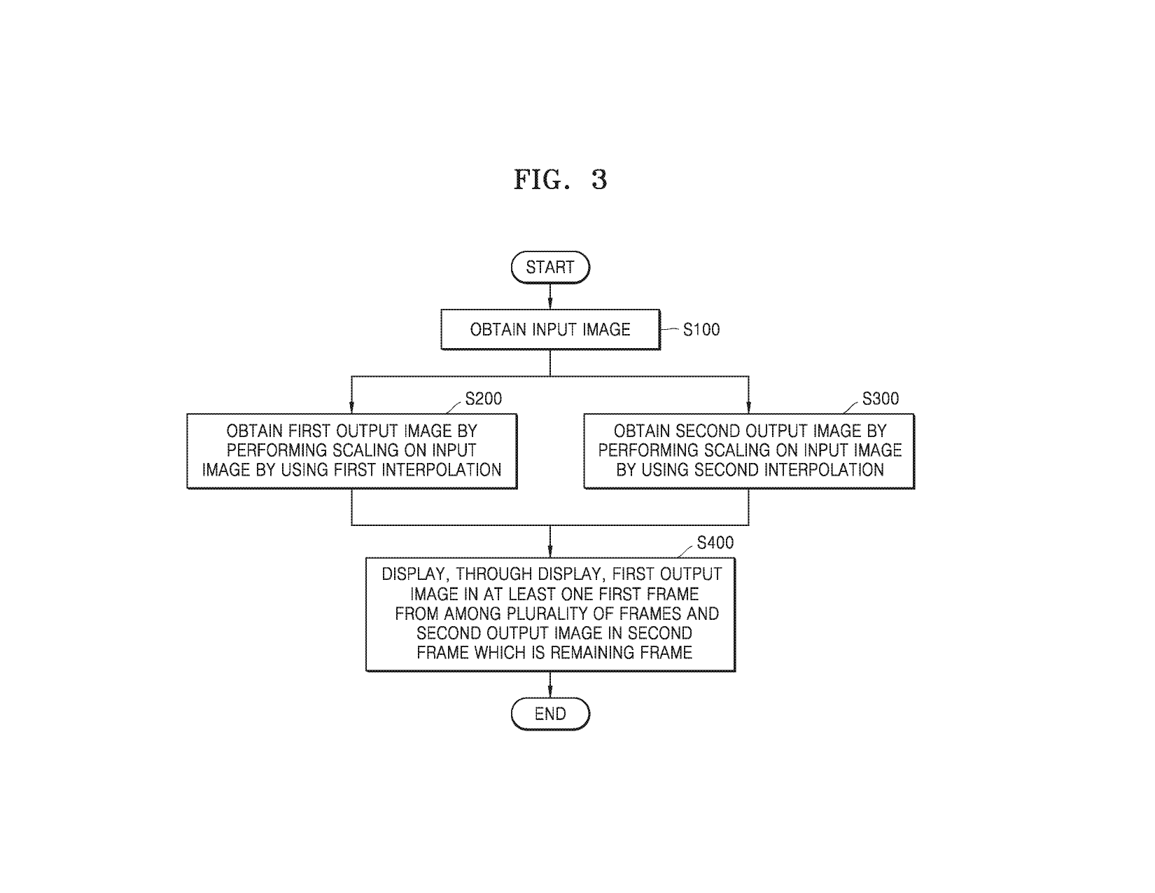

FIG. 3 is a flowchart illustrating an example operation of the electronic device 100, according to various embodiments.

Referring to FIGS. 1, 2, and 3, according to an embodiment of the disclosure, an operating method of the electronic device 100 may include an operation of obtaining the input image 200 (S100).

In operation S100, the electronic device 100 may obtain the input image 200 from an external electronic device or an external server through the input and output interface 160 or the communication interface 170.

According to an embodiment of the disclosure, the operating method of the electronic device 100 may include an operation of obtaining the first output image 300 by performing scaling on the input image 200 using a first interpolation method (S200).

In operation S200, the electronic device 100 may obtain the first output image 300 by performing scaling on the input image 200 using the first interpolation model 112.

According to an embodiment of the disclosure, the operating method of the electronic device 100 may include an operation of obtaining the second output image 310 by performing scaling on the input image 200 using a second interpolation method (S300).

In operation S300, the electronic device 100 may obtain the second output image 310 by performing scaling on the input image 200 using the second interpolation model 113.

According to an embodiment of the disclosure, operation S200 and operation S300 may be performed after operation S100. However, operation S220 and operation S300 may also be sequentially or simultaneously performed.

In operation S200, the electronic device 100 may obtain the first output image 300 by performing scaling on the input image 200 using the first scaler 140. Also, in operation S300, the electronic device 100 may obtain the second output image 310 by performing scaling on the input image 200 using the second scaler 150.

Hereinafter, the components of the electronic device 100 used to obtain the first output image 300 and the second output image 310 in operation S200 and operation S300 are to be described in greater detail below with reference to FIGS. 11 and 12.

According to an embodiment of the disclosure, the operating method of the electronic device 100 may include an operation of displaying, through the display 120, the first output image 300 in at least one first frame from among a plurality of output frames and the second output image 310 in a second frame, which is a remaining frame (S400).

In operation S400, the electronic device 100 may display, through the display 120, the first output image 300 in the at least one first frame from among the plurality of output frames and the second output image 310 in the second frame, which is the remaining frame. A period of the second frame among the plurality of output frames may be pre-set. The period of the second frame among the plurality of output frames may be set according to the characteristic of the input image 200.

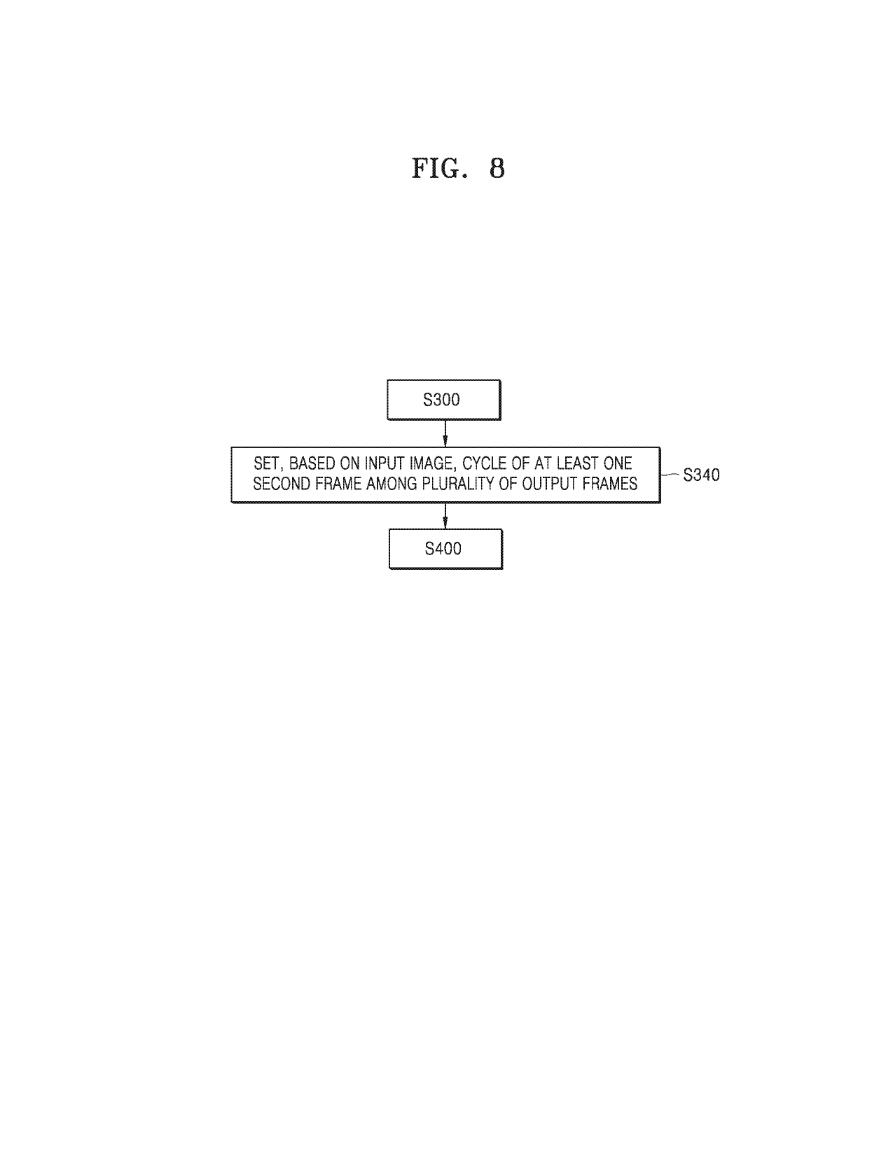

Hereinafter, the period of the second frame among the plurality of output frames is to be described in greater detail below with reference to FIGS. 8 to 10.

However, the disclosure is not limited thereto. The operating method of the electronic device 100 may further include, after operation S100, an operation of determining, based on the obtained input image 200, whether to perform scaling on the input image 200 using the first interpolation method and the second interpolation method which are different from each other.

According to an embodiment of the disclosure, when the input image 200 is a still image displaying the same image during a plurality of frames, such as a picture, a main screen, a home screen of a digital TV, a still image of a video, etc., and when an output image scaled using the same interpolation is continually displayed during the plurality of output frames, driving voltages applied to a plurality of OLEDs included in the display 120 may be constant, and thus, the possibility of burn-in of the plurality of OLEDs included in the display 120 may increase.

According to an embodiment of the disclosure, in the operation of determining whether to perform scaling on the input image 200 using the first interpolation method and the second interpolation method different from each other, the electronic device 100 may determine to perform scaling on the input image 200 using the first interpolation model 112 and the second interpolation model 113 different from each other, when it is determined that the input image 200 is a still image not changing during the plurality of frames. Thus, the electronic device 100 may perform the operations of operations S200 and S300.

According to an embodiment of the disclosure, in the operation of determining whether to perform scaling on the input image 200 using the first interpolation method and the second interpolation method different from each other, the electronic device 100 may determine to perform scaling on the input image 200 using any one of the first interpolation method or the second interpolation method, when it is determined that the input image 200 is a motion image continually changing during the plurality of frames.

In this case, the electronic device 100 may display, through the display 120, the output image obtained by performing scaling on the input image 200 using any one of the first interpolation model 112 or the second interpolation model 113 during the plurality of output frames.

However, the disclosure is not limited thereto, and regardless of whether the input image 200 is a still image or a motion image, the electronic device 100 may be pre-set to perform scaling using the first interpolation method and the second interpolation method different from each other, and in this case, the operation of determining whether to perform scaling on the input image 200 using the first interpolation method and the second interpolation method different from each other may be omitted.

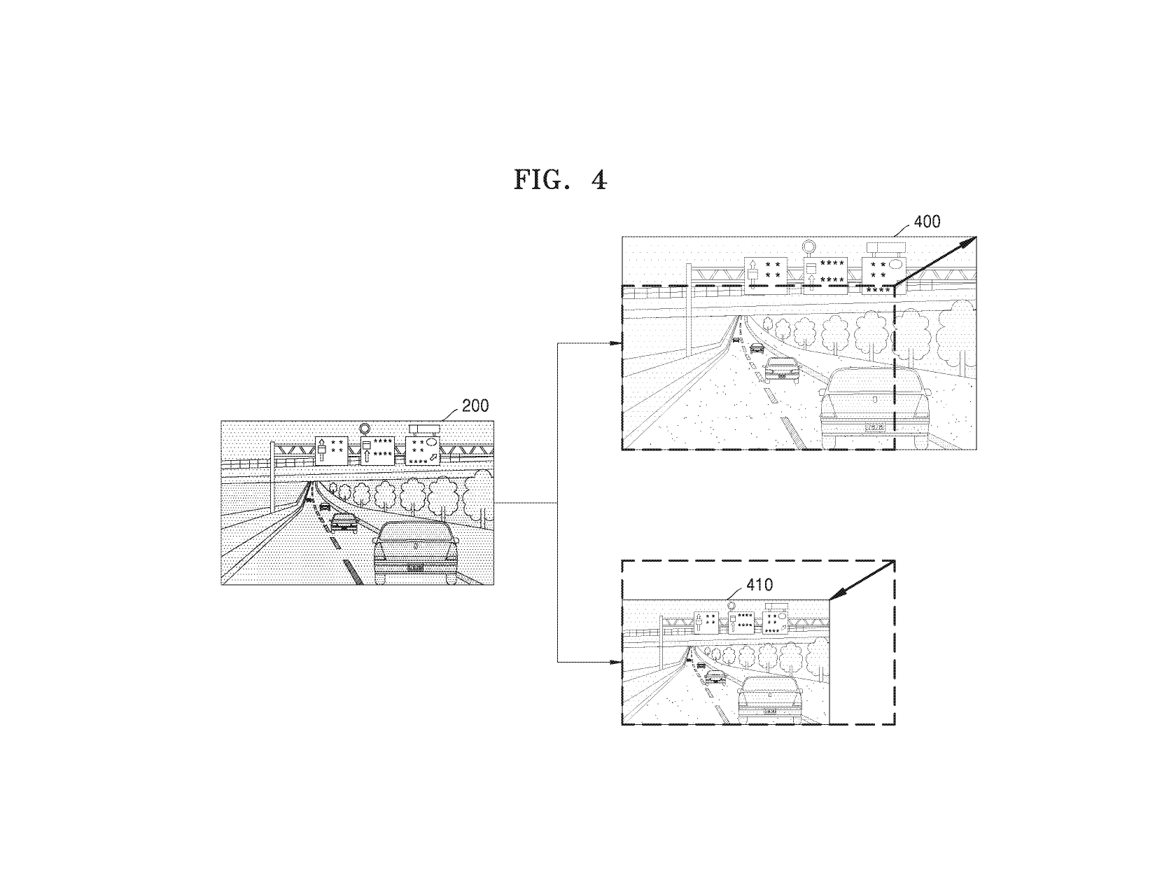

FIG. 4 is a diagram illustrating an example operation of performing scaling for adjusting a size of an image, according to various embodiments.

Referring to FIGS. 1, 2, and 4, the input image 200 is illustrated in FIG. 4, according to an embodiment of the disclosure. According to an embodiment of the disclosure, the electronic device 100 may adjust a size of a display area of the display 120, on which the output image is displayed.

According to an embodiment of the disclosure, the electronic device 100 may adjust the display area to be entirely included in the whole screen of the display 120 or adjust the size of the display area by dragging the display area through a user interface, such as a mouse, etc. The electronic device 100 may control the display area to be included in the display 120 as a multi-window or a pop-up window.

According to an embodiment of the disclosure, as the size of the display area of the display 120, on which the output image is displayed, is adjusted, the resolution of the output image may be changed. According to an embodiment of the disclosure, as the display area increases, the output image displayed on the corresponding area may have an increased resolution. As the display area decreases, the output image displayed on the corresponding area may have a decreased resolution.

According to an embodiment of the disclosure, FIG. 4 illustrates two size-adjusted images which are obtained through scaling on the input image 200, based on the adjusting of the size of the display area.

According to an embodiment of the disclosure, as the size of the display area increases, the electronic device 100 may obtain, through scaling on the input image 200, a first size-adjusted image 400 having a greater resolution than the input image 200. As the size of the display area decreases, the electronic device 100 may obtain, through scaling on the input image 200, a second size-adjusted image 410 having a less resolution than the input image 200.

According to an embodiment of the disclosure, each of the first size-adjusted image 400 and the second size-adjusted image 410 may be displayed on the display area of the display 120 as the output image.

According to an embodiment of the disclosure, the electronic device 100 may perform scaling on the input image 200 using two different interpolation methods in order to obtain the first size-adjusted image 400 or the second size-adjusted image 410. According to an embodiment of the disclosure, the first output image 300 and the second output image 310 illustrated in FIG. 1 may be size-adjusted images obtained by scaling the input image 200 using two different interpolation methods.

However, the disclosure is not limited thereto. The size of the output image obtained through scaling on the input image 200 may not change. The size of the output image may be the same as the size of the input image 200, and the resolution of the output image may be different from the resolution of the input image 200. In detail, the size of the input image 200 and the size of the output image obtained by scaling the input image 200 may be the same as each other, and when the input image 200 has a full high definition (FHD) resolution, the output image may have an ultra high definition (UHD) resolution.

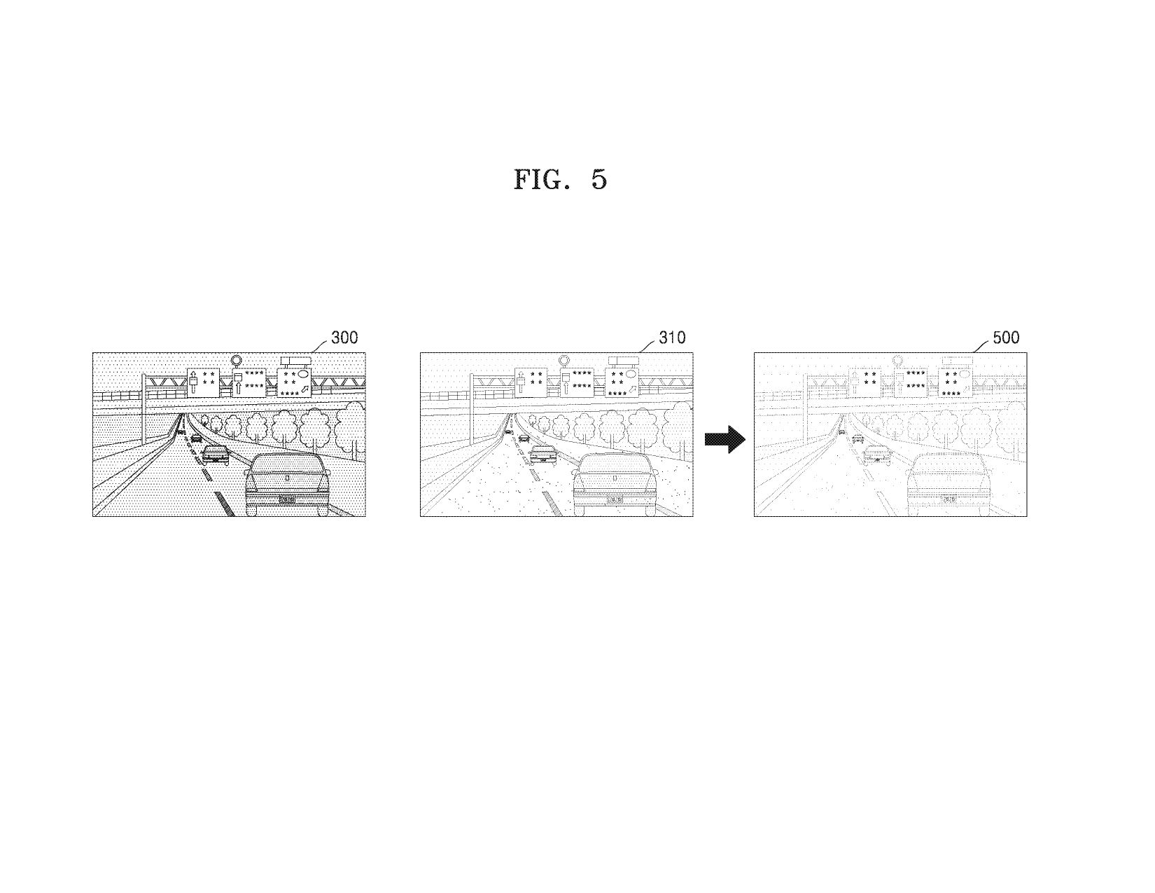

FIG. 5 is a diagram illustrating an example difference between different output images obtained by performing scaling using different interpolation methods, according to various embodiments.

Referring to FIGS. 1, 2, and 5, according to an embodiment of the disclosure, FIG. 5 illustrates the first output image 300 obtained using the first interpolation model 112 and the second output image 310 obtained using the second interpolation model 113.

According to an embodiment of the disclosure, according to types of interpolation algorithms, the number of pixels or the location of a pixel of the input image 200, used for obtaining gradation information of a specific pixel of the output image, may vary. Thus, there may be a difference between gradation information of a plurality of pixels included in the first output image 300 and gradation information of a plurality of pixels included in the second output image 310, the first output image 300 and the second output image 310 being obtained using the first interpolation model 112 and the second interpolation model 113, respectively, which include different interpolation algorithms.

According to an embodiment of the disclosure, any one pixel from among the plurality of pixels included in the first output image 300 may be referred to as a first pixel, and a pixel corresponding to the first pixel, from among the plurality of pixels included in the second output image 310, may be referred to as a second pixel.

According to an embodiment of the disclosure, the gradation information of the first pixel may be different from the gradation information of the second pixel. In detail, when the first pixel includes the gradation information of red, green, and blue of (128, 230, 170), the second pixel may include the gradation information of red, green, and blue of (130, 235, and 180). Here, the difference in gradation information between the first pixel and the second pixel may be (2, 5, 10).

FIG. 5 illustrates gradation difference information 500 between the first output image 300 and the second output image 310. The gradation difference information 500 may include the difference in gradation information of all of red, green, and blue. However, the disclosure is not limited thereto, and according to methods of performing scaling by the first interpolation model 112 and the second interpolation model 113, the gradation difference information 500 may include the difference in gradation information of at least one of red, green, or blue.

According to an embodiment of the disclosure, the display 120 may display the first output image 300 in at least one first frame during a plurality of output frames and the second output image 310 in a second frame which is a remaining frame. There may be the gradation difference information 500 between the first output image 300 and the second output image 310, and thus, the driving voltages applied to the plurality of OLEDs included in the display 120 may slightly vary during the plurality of output frames. Thus, it is possible to prevent and/or reduce burn-in of the plurality of OLEDs included in the display 120.

According to an embodiment of the disclosure, the input image 200 may include a still image (for example, a picture, a main screen, a home screen of a digital TV, a static screen of a video, etc.) including the same image during a plurality of input frames. Here, when the output image obtained based on the input image 200 is displayed on the display 120 throughout the plurality of output frames, the first output image 300 and the second output image 310 having the gradation difference information 500 and different from each other are displayed, and thus, it is possible to maximize/improve the effect of preventing/reducing burn-in of the plurality of OLEDs.

However, the disclosure is not limited thereto, and when the input image 200 includes a video including different images during the plurality of input frames, it is also possible to display, on the display 120, different output images obtained using scaling using different interpolation models according to the disclosure.

According to an embodiment of the disclosure, according to gradation information or a type of content of each of the plurality of pixels included in the input image 200, the gradation information of the first output image 300 obtained through the first interpolation model 112 may be the same as the gradation information of the second output image 310 obtained through the second interpolation model 113.

For example, when each of the plurality of pixels included in the input image 200 includes the same gradation information, and the arrangement of the plurality of pixels is regular, the first output image 300 and the second output image 310 obtained using the generally used interpolation algorithms (for example, the first interpolation model 112 using nearest neighbor interpolation and the second interpolation model 113 using bicubic interpolation) may include the same gradation information.

According to an embodiment of the disclosure, the second interpolation method included in the second interpolation model 113 may further include an algorithm pre-set to scale a pixel including pre-set first gradation information to a pixel including second gradation information set to be different from the first gradation information.

According to an embodiment of the disclosure, the first gradation information may indicate a greatest gradation value of the gradation information which may be included in a pixel. When the gradation information has values of 8 bits from 0 to 255, the first gradation information may be set as the gradation information of the value of 255. However, the disclosure is not limited thereto, and the first gradation information may be set as values of a certain section, as the gradation information of the values from 240 to 255.

According to an embodiment of the disclosure, the second gradation information may indicate values less than the greatest gradation value of the gradation information which may be included in the pixel. According to an embodiment of the disclosure, when the first gradation information is the gradation information having the value of 255, the second gradation information may be set to be the gradation information of the value of 250. However, the disclosure is not limited thereto. When the first gradation information is set to be the gradation information of values of a certain section from 240 to 255, the second gradation information may be set to be the gradation information of a value less than the certain section, for example, the gradation information of the value of 235 or the gradation information of a value included in the certain section, for example, 240.

Because the second output image 310 may be obtained using the second interpolation method including the pre-set algorithm, the electronic device 100 may obtain the first output image 300 and the second output image 310 having the gradation difference information 500.

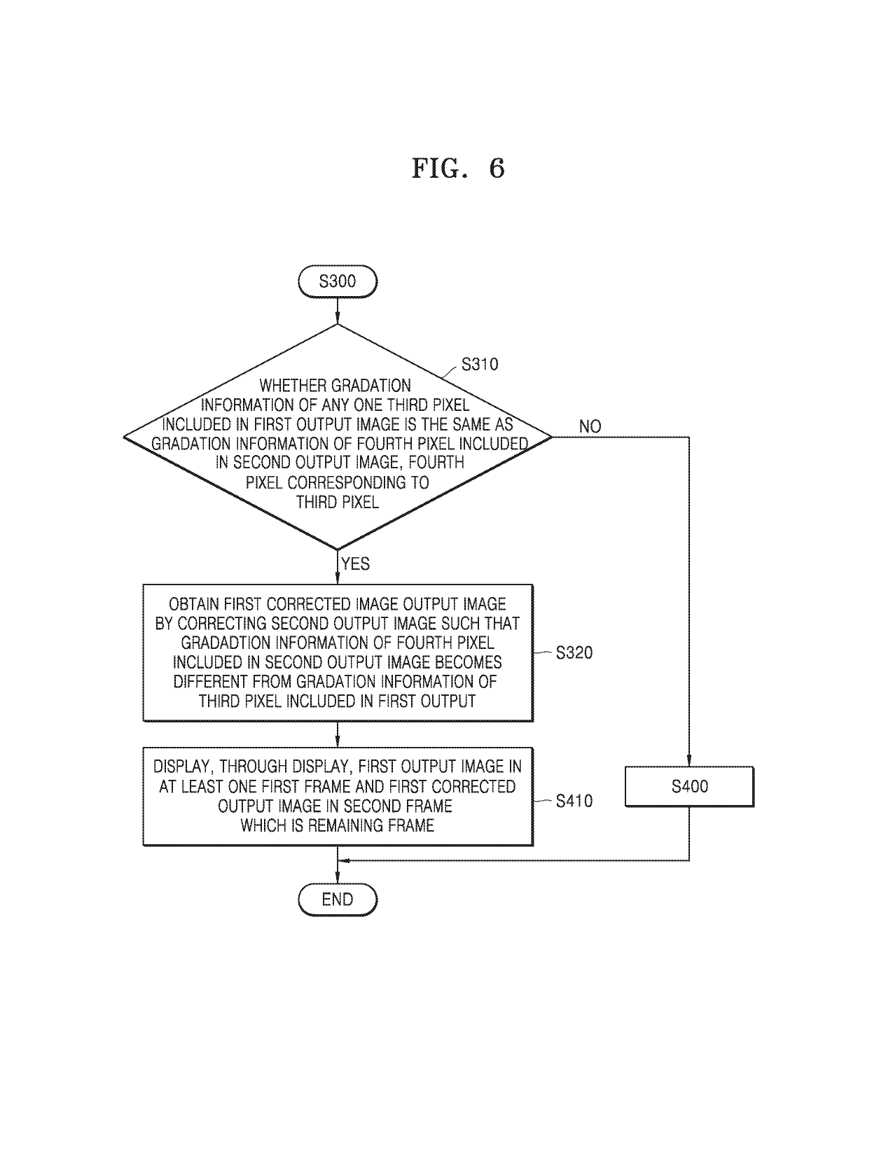

FIG. 6 is a flowchart illustrating an example operation of correcting a second output image such that gradation information of pixels included in a first output image and the second output image become different from each other, according to various embodiments. Hereinafter, the same operations as described with reference to FIG. 3 are given the same reference numerals, and redundant descriptions may not be repeated.

Referring to FIGS. 1, 2, 3, and 6, according to an embodiment of the disclosure, an operating method of the electronic device 100 may include an operation of identifying, based on the first output image 300 and the second output image 310, whether gradation information of any one third pixel from among a plurality of pixels included in the first output image 300 is the same as gradation information of a fourth pixel from among a plurality of pixels included in the second output image 310, the fourth pixel corresponding to the third pixel (S310).

In operation S310, the electronic device 100 may compare the first output image 300 obtained through the first interpolation model 112 with the second output image 310 obtained through the second interpolation model 113. The electronic device 100 may identify whether or not the gradation information of any one third pixel from among the plurality of pixels included in the first output image 300 is the same as the gradation information of the fourth pixel corresponding to the third pixel from among the plurality of pixels included in the second output image.

According to an embodiment of the disclosure, operation S310 may be performed after operation S300 (see, e.g., FIG. 3).

According to an embodiment of the disclosure, when it is identified that the gradation information of the third pixel is the same as the gradation information of the fourth pixel in operation S310, the operating method of the electronic device 100 may include an operation of obtaining a first corrected output image by correcting the second output image 310 such that the gradation information of the fourth pixel included in the second output image 310 becomes different from the gradation information of the third pixel included in the first output image 300 (S320).

In operation S320, the electronic device 100 may obtain the first corrected output image by correcting, through the image correction module 114, the second output image 310 such that the gradation information of the fourth pixel included in the second output image 310 becomes different from the gradation information of the third pixel included in the first output image 300.

According to an embodiment of the disclosure, the electronic device 100 may correct the second output image through the image correction module 114 such that the fourth pixel included in the second output image 310 has pre-set gradation information. The electronic device 100 may obtain the first corrected output image by correcting, through the image correction module 114, the gradation information of the fourth pixel included in the second output image 310 to be decreased by a pre-set ratio.

Thus, the electronic device 100 may obtain the first output image 300 and the first corrected output image having gradation difference information.

According to an embodiment of the disclosure, the operating method of the electronic device 100 may include an operation of displaying, through the display 120, the first output image 300 in at least one first frame and the first corrected output image in at least one second frame from among a plurality of output frames (S410).

In operation S410, the electronic device 100 may display, through the display 120, the first output image 300 in the at least one first frame and the first corrected output image in the at least one second frame from among the plurality of output frames.

According to an embodiment of the disclosure, when it is identified that the gradation information of the third pixel is different from the gradation information of the fourth pixel in operation S310, the electronic device 100 may perform the operation of operation S400 (see, e.g., FIG. 3).

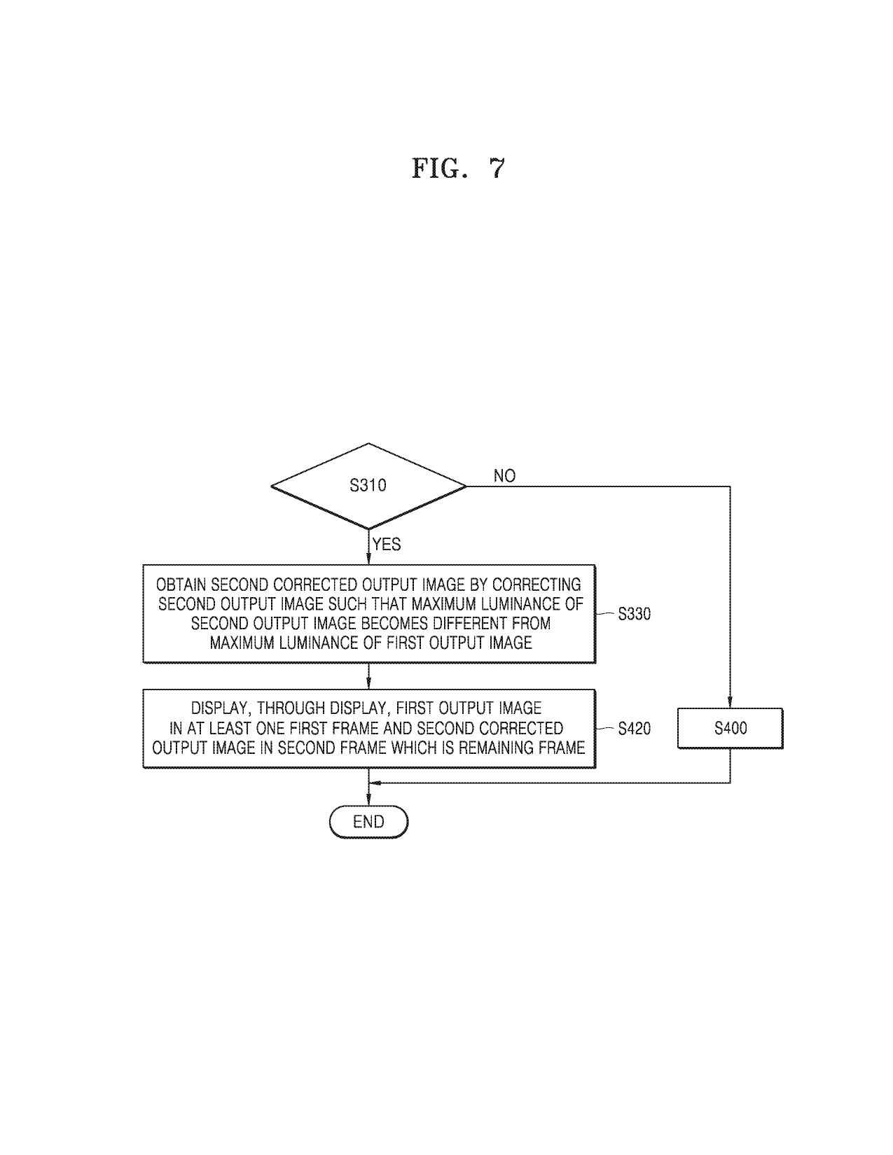

FIG. 7 is a flowchart illustrating an example operation of correcting a second output image, such that a maximum luminance of a first output image and a maximum luminance of the second output image become different from each other, according to various embodiments. Hereinafter, the same operations as described with reference to FIGS. 3 and 6 are given the same reference numerals, and redundant descriptions may not be repeated.

Referring to FIGS. 1, 2, 3, and 7, according to an embodiment of the disclosure, when it is identified that the gradation information of the third pixel is the same as the gradation information of the fourth pixel in operation S310, the operating method of the electronic device 100 may include an operation of obtaining a second corrected output image by correcting the second output image 310 such that the maximum luminance of the second output image 310 becomes different from the maximum luminance of the first output image 300 (S330).

In operation S330, the electronic device 100 may obtain the second corrected output image by correcting, through the luminance correction module 115, the second output image 310 such that the maximum luminance of the second output image 310 becomes different from the maximum luminance of the first output image 300.

According to an embodiment of the disclosure, when any one pixel included in each of the first output image 300 and the second output image 310 has greatest gradation information (for example, a value of 255 based on 8 bits), the maximum luminance of a corresponding pixel in each of the first output image 300 and the second output image 310 in the display 120 may be the same as each other.

In operation S330, as the electronic device 100 adjusts the maximum luminance of the second output image 310 to be different from the maximum luminance of the first output image 300 through the luminance correction module 115, the maximum luminance of the corresponding pixel in each of the first output image 300 and the second output image 310 in the display 120 may be different from each other.

For example, when the electronic device 100 changes the maximum luminance of the second output image 310 from 500 nit to 495 nit, in the display, the maximum luminance of the corresponding pixel of the first output image 300 may be 500 nit, and the maximum luminance of the corresponding pixel of the second output image 310 may be 495 nit so as to be different from each other.

According to an embodiment of the disclosure, the operating method of the electronic device 100 may include an operation of displaying, through the display 120, the first output image 300 in at least one first frame and the second corrected output image in at least one second frame from among a plurality of output frames (S420).

According to an embodiment of the disclosure, although the gradation information of the third pixel of the first output image 300 is the same as the gradation information of the fourth pixel of the second output image 310, the maximum luminance is different between the first output image 300 and the second output image 310, and thus, a driving voltage applied to display each of the third pixel and the fourth pixel on the OLED included in the display 120 may be different from each other. Thus, problems caused by burn-in of the plurality of OLEDs included in the display 120 may be prevented/reduced.

In operation S420, the electronic device 100 may display, through the display 120, the first output image 300 in the at least one first frame and the second corrected output image in the at least one second frame from among the plurality of output frames

According to an embodiment of the disclosure, when it is identified that the gradation information of the third pixel is different from the gradation information of the fourth pixel in operation S310, the electronic device 100 may perform the operation of operation S400 (see, e.g., FIG. 3).

FIG. 8 is a flowchart illustrating an example operation of setting a period of at least one second frame among a plurality of output frames, according to various embodiments. Hereinafter, the same operations as described with reference to FIG. 3 are given the same reference numerals, and redundant descriptions may not be repeated.

Referring to FIGS. 1, 2, 3, and 8, according to an embodiment of the disclosure, the operating method of the electronic device 100 may include an operation of setting the period of the at least one second frame among the plurality of output frames, based on the input image 200 (S340). The "period of the second frame" may denote the frequency included in the second frame among the plurality of output frames. For example, when the second frame includes a plurality of frames, as the period of the second frame decreases, a gap between the plurality of second frames included in the plurality of output frames may decrease, and the number of second frames included in the plurality of output frames may increase.

According to an embodiment of the disclosure, operation S340 may be performed after operation S300.

In operation S340, the electronic device 100 may set, through the period setting module 116, based on the input image 200, the period of at least one second frame among the plurality of output frames. For example, the electronic device 100 may set the period of the at least one second frame among the plurality of output frames by taking into account the degree of change of the input image 200 in a plurality of input frames, the ratio of a certain color in the input image 200, a size of gradation information included in the input image 200, etc.

According to an embodiment of the disclosure, the electronic device 100 may set the period of the second frame to decrease among the plurality of output frames, as the degree of change of the input image 200 in the plurality of input frames decreases. The electronic device 100 may set the period of the second frame to decrease among the plurality of output frames as a ratio of a certain color in the input image 200 increases, for example, when a ratio of blue exceeds 50%, etc. The electronic device 100 may set the period of the second frame to decrease among the plurality of output frames, as a value of the gradation information included in the input image 200 increases.

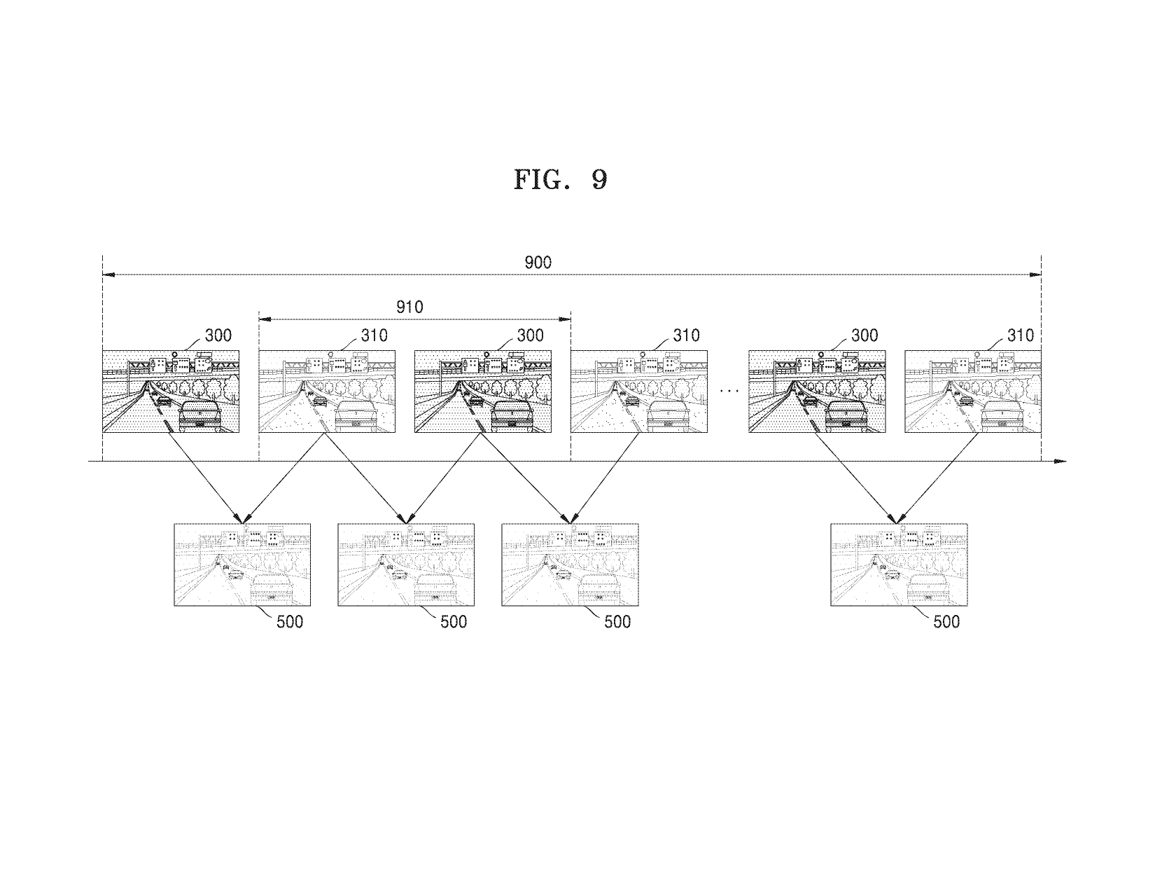

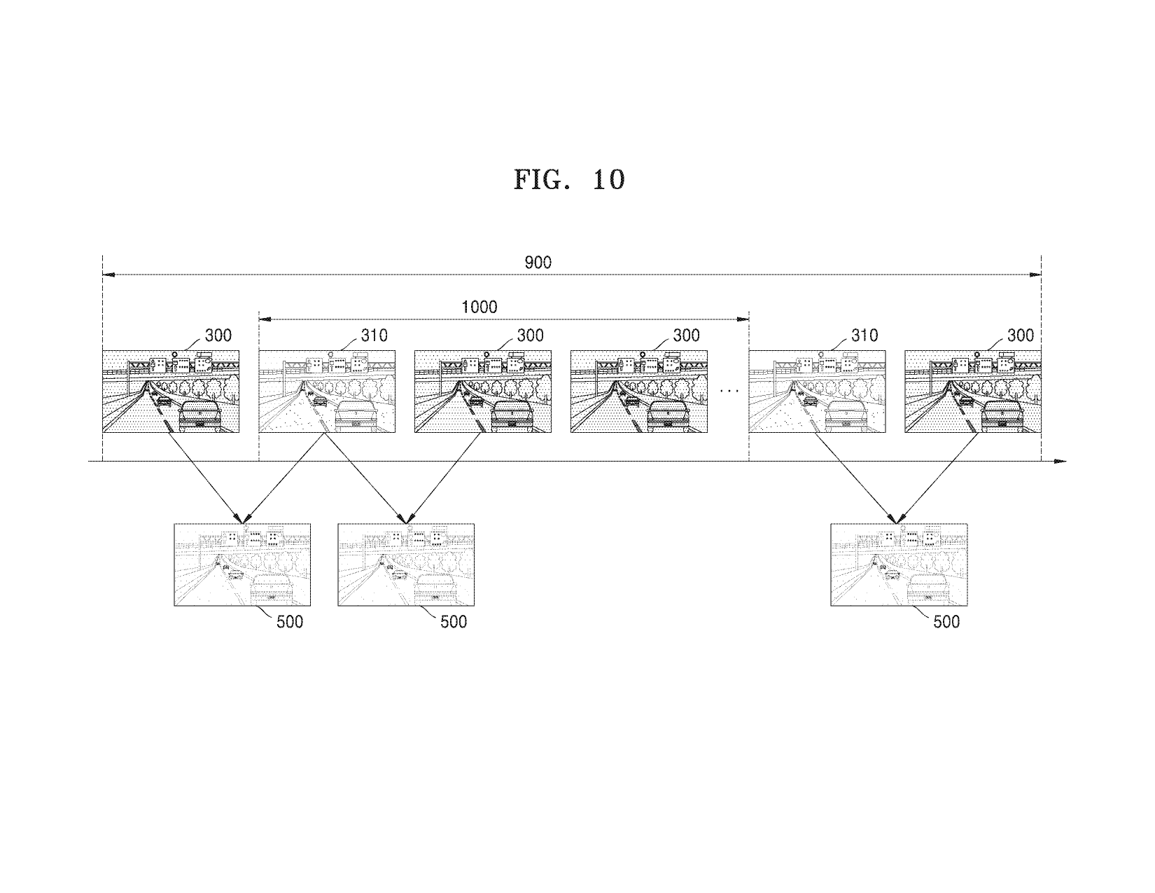

FIG. 9 is a diagram illustrating an example operation of displaying a first output image in at least one first frame from among a plurality of output frames and a second output image in at least one second frame, which is a remaining frame, according to various embodiments. FIG. 10 is a diagram illustrating an example operation of displaying a first output image in at least one first frame from among a plurality of output frames and a second output image in at least one second frame, which is a remaining frame, according to various embodiments.

Referring to FIGS. 1, 2, and 9, according to an embodiment of the disclosure, FIG. 9 illustrates the first output image 300 displayed in the at least one first frame included in the plurality of output frames and the second output image 310 displayed in the second frame, which is the remaining frame.

According to an embodiment of the disclosure, the plurality of output frames may denote frames displayed on the display 120 for one second, according to the driving frequency of the display 120. The plurality of output frames may be included in a driving period 900 of the display 120.

According to an embodiment of the disclosure, the at least one first frame may include a plurality of first frames. The remaining second frame may include a plurality of second frames. The sum of the number of first frames and the number of second frames may be the same as the number of output frames.

According to an embodiment of the disclosure, FIG. 9 illustrates that the plurality of first frames and the plurality of second frames are alternately arranged among the plurality of output frames. The display 120 may alternately display the first output image 300 and the second output image 310.

According to an embodiment of the disclosure, when the output image displayed on the display 120 during the plurality of output frames is a still image as well as a video, there may be the gradation difference information 500 between the first output image 300 and the second output image 310 alternately displayed on the display 120, and thus, driving voltages continually changing may be applied to the plurality of OLEDs included in the display 120.

Referring to FIGS. 1, 2, 9, and 10, according to an embodiment of the disclosure, FIG. 10 illustrates the first output image 300 displayed in a plurality of first frames included in a plurality of output frames and the second output image 310 displayed in a plurality of second frames which are remaining frames.

According to an embodiment of the disclosure, FIG. 10 illustrates that two second frames are arranged among the plurality of output frames. The plurality of first frames may be arranged among the remaining frames of the plurality of output frames. The first output image 300 may be displayed on the display 120 during the plurality of first frames, and the second output image 310 may be displayed on the display 120 during the two second frames.

According to an embodiment of the disclosure, a period 1000 of the plurality of second frames among the plurality of output frames illustrated in FIG. 10 may be longer than a period 910 of the plurality of second frames among the plurality of output frames illustrated in FIG. 9. As the period of the plurality of second frames among the plurality of output frames increases, a gap between the plurality of second frames included in the plurality of output frames may increase, and the number of second frames included in the plurality of output frames may decrease.

According to an embodiment of the disclosure, there may be the gradation difference information 500 in a section in which the first output image 300 and the second output image 310 are alternately displayed on the display 120. There may not be the gradation difference information in a section in which the first output image 300 is continually displayed.

According to an embodiment of the disclosure, the period of the plurality of second frames among the plurality of output frames may be pre-set according to the characteristic of the display 120 or may be set according to the characteristic of the input image 200.

As the period of the plurality of second frames increases among the plurality of output frames, a section providing the same image to the user 101 watching the electronic device 100 may increase, and thus, the visibility of the user may not be disturbed. The frequency of the operation of obtaining the output image using different interpolation methods may also be reduced, and thus, power consumption of the electronic device 100 may be reduced.

As the period of the plurality of second frames among the plurality of output frames decreases, a time period during which driving voltages having a constant size are applied to the plurality of OLEDs included in the display 120 may decrease, and thus, problems caused by burn-in of the plurality of OLEDs may be reduced.

The electronic device 100 according to the disclosure may use the appropriately set period of the plurality of second frames among the plurality of output frames, by taking into account the characteristic of the display 120 or the characteristic of the input image 200.

FIG. 11 is a block diagram illustrating an example operation of obtaining different output images using a plurality of scalers configured to perform different interpolation methods, according to various embodiments. FIG. 12 is a block diagram illustrating an example operation of obtaining different output images using an interpolation model stored in a memory and a scaler configured to perform a different interpolation method from the interpolation model included in the memory, according to various embodiments. Hereinafter, the same components as described with reference to FIG. 2 are given the same reference numerals, and redundant descriptions may not be repeated.

Referring to FIGS. 1, 2, and 11, according to an embodiment of the disclosure, the electronic device 100 may include the first scaler 140 configured to execute the first interpolation model 112 and the second scaler 150 configured to perform the second interpolation model 113.

According to an embodiment of the disclosure, the electronic device 100 may obtain the first output image 300 by performing scaling on the input image 200 using the first scaler 140.

In this case, the memory 110 may not include the first interpolation model 112 and the second interpolation model 113. The electronic device 100 may obtain the first output image 300 and the second output image 310 using the first scaler 140 and the second scaler 150, respectively, without executing instructions or program codes of the image scaling module 111 stored in the memory 110 using the at least one processor 130.

FIGS. 2 and 11 illustrate the first scaler 140 and the second scaler 150 as separate components, but the disclosure is not limited thereto. According to an embodiment of the disclosure, the first scaler 140 and the second scaler 150 may also be designed as one component to separately perform the operations of the first interpolation model 112 and the second interpolation model 113.

Referring to FIGS. 1, 2, and 12, according to an embodiment of the disclosure, the electronic device 100 may include the first interpolation model 112 in the image scaling module 111 and may include the second scaler 150 configured to perform the second interpolation model 113.

According to an embodiment of the disclosure, the electronic device 100 may execute, through the at least one processor 130, the instructions or program codes of the image scaling module 111 stored in the memory 110 to obtain the first output image 300 by performing scaling on the input image 200 using the first interpolation model 112. The electronic device 100 may obtain the second output image 310 by performing scaling on the input image 200 using the second scaler 150.

In this case, the memory 110 may not include the second interpolation model 113. The electronic device 100 may obtain the first output image 300 and the second output image 310 through the operation of executing the instructions or program codes of the image scaling module 111 stored in the memory 110 and the operation of using the second scaler 150.

However, the disclosure is not limited thereto, and the first interpolation model 112 and the second interpolation model 113 may be stored in the image scaling module 111, and the electronic device 100 may execute the instructions or program codes of the image scaling module 111 stored in the memory 110 to obtain the first output image 200 and the seconds output image 310 by performing scaling on the input image 200 using the first interpolation model 112 and the second interpolation model 113, respectively.

According to an embodiment of the disclosure, it is illustrated that the electronic device 100 performs scaling on the input image 200 using the first interpolation model 112 and the second interpolation model 113, but the disclosure is not limited thereto. The electronic device 100 may also obtain three or more different output images by performing scaling on the input image 200 using three or more interpolation models including three or more different interpolation algorithms.

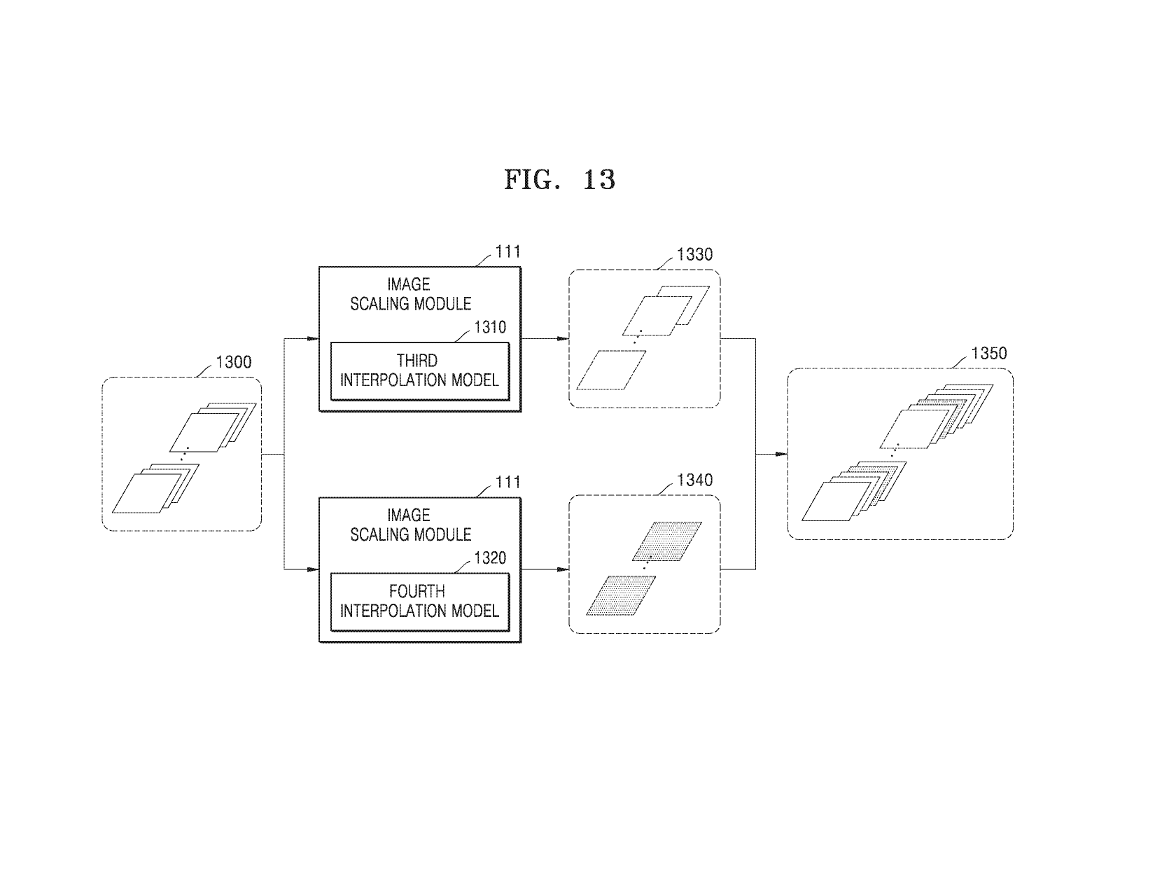

FIG. 13 is a diagram illustrating an example operation of generating an output image including each of a plurality of correction frames using different interpolation methods for providing an image at a different frequency from an input image, according to various embodiments.

Referring to FIGS. 1, 2, and 13, according to an embodiment of the disclosure, the image scaling module 111 may further include a third interpolation model 1310 and a fourth interpolation model 1320. The third interpolation model 1310 and the fourth interpolation model 1320 may include different interpolation algorithms for obtaining an output image corresponding to a correction frame based on the input image 1300, in order to display the output image by a frequency different from a frequency of an input image 1300.

According to an embodiment of the disclosure, the input image 1300 may include a plurality of input frames corresponding to an input frequency. An output image 1350 displayed by the electronic device 100 through the display 120 may include a plurality of output frames corresponding to an output frequency.

According to an embodiment of the disclosure, the input frequency of the input image 1300 obtained by the electronic device 100 may be different from the output frequency of the output image to be displayed through the display 120.

According to an embodiment of the disclosure, the input image 1300 may be an image having a frequency of 60 Hz. The input image 1300 may include images corresponding to a plurality of input frames corresponding to the frequency of 60 Hz. According to an embodiment of the disclosure, the output image 1350 may be displayed through the display 120 by a frequency of 120 Hz. The electronic device 100 may require an image corresponding to the plurality of output frames corresponding to the frequency of 120 Hz in order to display the output image 1350 by the frequency of 120 Hz.

According to an embodiment of the disclosure, the electronic device 100 may obtain a third output image 1330 including a plurality of first correction frames, by performing scaling on the input image 1300 using the third interpolation model 1310 included in the image scaling module 111. The electronic device 100 may obtain a fourth output image 1340 including a plurality of second correction frames, by performing scaling on the input image 1300 using the fourth interpolation model 1320 included in the image scaling module 111.

According to an embodiment of the disclosure, the sum of the number of first correction frames and the number of second correction frames may be the same as the difference between the number of output frames and the number of input frames.

According to an embodiment of the disclosure, when the input frequency is 60 Hz and the output frequency is 120 Hz, 60 input frames may be required for one second, and 120 output frames may be required for one second. The electronic device 100 may obtain a plurality of output images corresponding to 60 correction frames through the image scaling module 111.

According to an embodiment of the disclosure, according to types of interpolation algorithms, a combination of input frames of the input image 1300, the number of pixels included in the input image, a location of a pixel, or the like, used for obtaining gradation information of a specific pixel of the output image may vary. Thus, there may be a difference between gradation information of a plurality of pixels included in the third output image 1330 and gradation information of a plurality of pixels included in the fourth output image 1340, the third output image 1330 and the fourth output image 1340 being respectively obtained using the third interpolation model 1310 and the fourth interpolation model 1320 including different interpolation algorithms.

According to an embodiment of the disclosure, the display 120 may display the input image 1300 in the plurality of input frames, the third output image 1330 in the plurality of first correction frames, and the fourth output image 1340 in the plurality of second correction frames, among the plurality of output frames. The third output image 1330 may include a plurality of images respectively corresponding to the plurality of first correction frames. The fourth output image 1340 may include a plurality of images respectively corresponding to the plurality of second correction frames.

For example, when the input frequency is 60 Hz and the output frequency is 120 Hz, the electronic device 100 may display images included in the plurality of input frames of the input image 1300 during 60 output frames from among 120 output frames displayed for one second. The electronic device 100 may display the third output image 1330 in the plurality of first correction frames and the fourth output image 1340 in the plurality of second correction frames from among the 60 remaining output frames.

According to an embodiment of the disclosure, there may be gradation difference information between the input image 1300, the third output image 1330, and the fourth output image 1340 displayed on the display 120, and thus, driving voltages applied to the plurality of OLEDs included in the display 120 may come to slightly vary during the plurality of output frames. Thus, problems of burn-in of the plurality of OLEDs included in the display 120 may be prevented/reduced.

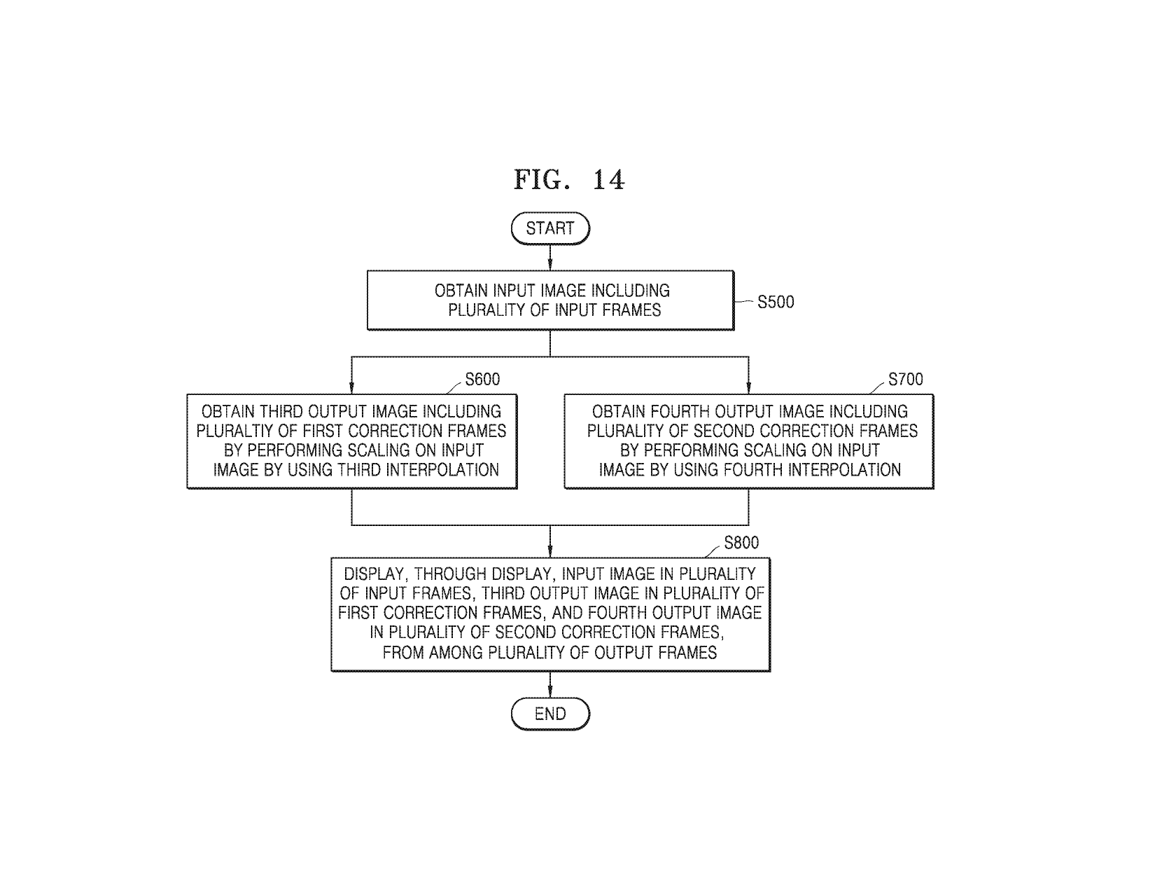

FIG. 14 is a flowchart illustrating an example operation of generating an output image including each of a plurality of correction frames using different interpolation methods for providing an image at a different frequency from an input image, according to various embodiments.

Referring to FIGS. 1, 2, 13, and 14, according to an embodiment of the disclosure, an operating method of the electronic device 100 may include an operation of obtaining the input image 1300 including the plurality of input frames (S500).

In operation S500, the electronic device 100 may obtain the input image 1300 from an external electronic device or an external server through the input and output interface 160 or the communication interface 170.

According to an embodiment of the disclosure, the operating method of the electronic device 100 may include an operation of obtaining the third output image 1330 including the plurality of first correction frames by performing scaling on the input image 1300 using a third interpolation method (S600).

In operation S600, the electronic device 100 may obtain the third output image 1330 including the plurality of first correction frames by performing scaling on the input image 1300 using the third interpolation model 1310.

According to an embodiment of the disclosure, the operating method of the electronic device 100 may include an operation of obtaining the fourth output image 1340 including the plurality of second correction frames by performing scaling on the input image 1300 using a fourth interpolation method (S700).

In operation S700, the electronic device 100 may obtain the fourth output image 1340 including the plurality of second correction frames by performing scaling on the input image 1300 using the fourth interpolation model 1320.

According to an embodiment of the disclosure, operation S600 and operation S700 may be performed after operation S500. However, operation S600 and operation S700 may be sequentially or simultaneously performed.

The electronic device 100 may include a third scaler configured to perform the third interpolation model 1310 and a fourth scaler configured to perform the fourth interpolation model 1320.

In operation S600, the electronic device 100 may obtain the third output image 1330 including the plurality of first correction frames by performing scaling on the input image 1300 using the third scaler. In operation S700, the electronic device 100 may obtain the fourth output image 1340 including the plurality of second correction frames by performing scaling on the input image 1300 using the fourth scaler.

According to an embodiment of the disclosure, the operating method of the electronic device 100 may include an operation of displaying, through the display 120, the input image 1300 in the plurality of input frames, the third output image 1330 in the plurality of first correction frames, and the fourth output image 1340 in the plurality of second correction frames, from among the plurality of output frames (S800).

According to an embodiment of the disclosure, the period of the plurality of first correction frames among the plurality of output frames and the period of the plurality of second correction frames among the plurality of output frames may be pre-set according to the characteristic of the display 120. The period of the plurality of first correction frames among the plurality of output frames and the period of the plurality of second correction frames among the plurality of output frames may be set according to the characteristic of the input image 200.

In operation S800, the electronic device 100 may display, through the display 120, the input image 1300 in the plurality of input frames, the third output image 1330 in the plurality of first correction frames, and the fourth output image 1340 in the plurality of second correction frames, among the plurality of output frames.

To address the technical problem described above, according to an example embodiment of the disclosure, an electronic device is provided. The electronic device may include a display. The electronic device may include memory storing a program or at least one instruction. The electronic device may include at least one processor including processing circuitry. The at least one processor may individually or collectively execute the program or the at least one instruction stored in the memory to cause the electronic device to obtain an input image. The electronic device may obtain a first output image by performing scaling on the input image using first interpolation. The electronic device may obtain a second output image by performing scaling on the input image using second interpolation different from the first interpolation. The electronic device may display, through the display, the first output image in at least one first frame from among a plurality of output frames and the second output image in at least one second frame, which is a remaining frame.

According to an example embodiment of the disclosure, in the electronic device, each of the first output image and the second output image may include a plurality of pixels. Gradation information included in any one first pixel from among the plurality of pixels included in the first output image may be different from gradation information included in a second pixel from among the plurality of pixels included in the second output image, the second pixel corresponding to the first pixel.

According to an example embodiment of the disclosure, a resolution of the first output image may be same as a resolution of the second output image as a first resolution. A resolution of the input image may be a second resolution different from the first resolution.

According to an example embodiment of the disclosure, the second interpolation may include an algorithm pre-set to scale a pixel including pre-set first gradation information to a pixel including second gradation information differently set from the first gradation information.

According to an example embodiment of the disclosure, the electronic device may identify, based on the first output image and the second output image, whether or not gradation information of any one third pixel from among the plurality of pixels included in the first output image is same as gradation information of a fourth pixel from among the plurality of pixels included in the second output image, the fourth pixel corresponding to the third pixel. When it is identified that the gradation information of the third pixel is the same as the gradation information of the fourth pixel, the electronic device may obtain a first corrected output image by correcting the second output image such that the gradation information of the fourth pixel included in the second output image becomes different from the gradation information of the third pixel included in the first output image. The electronic device may display, through the display, the first output image in the at least one first frame and the first corrected output image in the at least one second frame.

According to an example embodiment of the disclosure, the electronic device may identify, based on the first output image and the second output image, whether or not gradation information of any one third pixel from among the plurality of pixels included in the first output image is same as gradation information of a fourth pixel from among the plurality of pixels included in the second output image, the fourth pixel corresponding to the third pixel. When it is identified that the gradation information of the third pixel is the same as the gradation information of the fourth pixel, the electronic device may obtain a second corrected output image by correcting the second output image such that a maximum luminance of the second output image is different from a maximum luminance of the first output image. The electronic device may display, through the display, the first output image in the at least one first frame and the second corrected output image in the at least one second frame.

According to an example embodiment of the disclosure, a period of the at least one second frame among the plurality of output frames may be pre-set based on a characteristic of the display.

According to an example embodiment of the disclosure, the electronic device may differently set, based on the input image, the period of the at least one second frame among the plurality of output frames.

According to an example embodiment of the disclosure, the electronic device may further include a first scaler configured to perform the first interpolation The electronic device may further include a second scaler configured to perform the second interpolation, The electronic device may obtain the first output image by performing scaling on the input image using the first scaler. The electronic device may obtain the second output image by performing scaling on the input image using the second scaler.

According to an example embodiment of the disclosure, the electronic device may further include a third scaler configured to perform any one interpolation of the first interpolation or the second interpolation. The electronic device may obtain any one of the first output image or the second output image by performing, through the third scaler, scaling on the input image using the any one interpolation. The at least one processor may be configured to execute the program or the at least one instruction stored in the memory 110 to cause the electronic device to obtain a remaining output image from the first output image or the second output image by performing scaling on the input image using a remaining interpolation method from the first interpolation or the second interpolation.

To address the technical problem described above, according to an example embodiment of the disclosure, an operating method of an electronic device may be provided. The operating method of the electronic device may include obtaining an input image. The operating method of the electronic device may include obtaining a first output image by performing scaling on the input image using first interpolation. The operating method of the electronic device may include obtaining a second output image by performing scaling on the input image using second interpolation different from the first interpolation. The operating method of the electronic device may include displaying, through a display, the first output image in at least one first frame from among a plurality of output frames and the second output image in at least one second frame, which is a remaining frame.

According to an example embodiment of the disclosure, the operating method of the electronic device may further include identifying, based on the first output image and the second output image, whether or not gradation information of any one third pixel from among the plurality of pixels included in the first output image is same as gradation information of a fourth pixel from among the plurality of pixels included in the second output image, the fourth pixel corresponding to the third pixel. The operating method of the electronic device may further include, when it is identified that the gradation information of the third pixel is the same as the gradation information of the fourth pixel, obtaining a first corrected output image by correcting the second output image such that the gradation information of the fourth pixel included in the second output image becomes different from the gradation information of the third pixel included in the first output image. The operating method of the electronic device may further include displaying, through the display, the first output image in the at least one first frame and the first corrected output image in the at least one second frame.

According to an example embodiment of the disclosure, the operating method of the electronic device may further include identifying, based on the first output image and the second output image, whether or not gradation information of any one third pixel from among the plurality of pixels included in the first output image is same as gradation information of a fourth pixel from among the plurality of pixels included in the second output image, the fourth pixel corresponding to the third pixel. The operating method of the electronic device may further include, when it is identified that the gradation information of the third pixel is the same as the gradation information of the fourth pixel, obtaining a second corrected output image by correcting the second output image such that a maximum luminance of the second output image is different from a maximum luminance of the first output image. The operating method of the electronic device may further include displaying, through the display, the first output image in the at least one first frame and the second corrected output image in the at least one second frame.

According to an example embodiment of the disclosure, the operating method of the electronic device may further include setting, based on the input image, the period of the at least one second frame among the plurality of output frames.

According to an example embodiment of the disclosure, the obtaining of the first output image may include obtaining the first output image by performing scaling on the input image using a first scaler configured to perform the first interpolation. The obtaining of the second output image may include obtaining the second output image by performing scaling on the input image using a second scaler configured to perform the second interpolation.

To address the technical problem described above, a non-transitory computer-readable recording medium having recorded thereon a program for executing, on a computer, at least one method of the operating method of the electronic device according to an example embodiment of the disclosure, may be provided.

Programs executed by the electronic device described herein may be implemented by a hardware component, a software component, and/or a combination of a hardware component and a software component. The programs may be performed by all systems capable of executing computer-readable instructions.

The software may include a computer program, a code, an instruction, or a combination of at least two thereof, and may configure a processing device or individually or collectively instruct the processing device to operate as desired.

The software may be implemented by a computer program including an instruction stored in computer-readable storage media. Computer-readable recording media may include, for example, magnetic storage media (e.g., ROM, RAM, a floppy disc, a hard disc, etc.), optical reading media (e.g., compact disc (CD)-ROM, a digital versatile disc (DVD), etc.), etc. The computer-readable recording media may be distributed in computer systems connected through a network and may store and execute computer-readable codes in a distributed fashion. Recording media may be readable by a computer, stored in a memory, and executed by a processor.

The computer-readable storage medium may include a non-transitory storage medium. Here, the "non-transitory storage media" denotes that the media are tangible devices and may not include signals (e.g., electromagnetic waves), and does not distinguish the storage media semi-permanently storing data and the storage media temporarily storing data. For example, the "non-transitory storage media" may include a buffer temporarily storing data.

The program according to various embodiments of the disclosure may be included in a computer program product. The computer program product may be transacted between a seller and a purchaser as a product.

The computer program product may include a software program or a computer-readable storage medium in which a software program is stored. For example, the computer program product may include a software program-type product (for example, a downloadable application) electronically distributed through a manufacturer of an electronic device or an electronic market (for example, Samsung galaxy store). For electronic distribution, at least part of a software program may be stored in a storage medium or temporarily generated. In this case, the storage medium may include a server of a manufacturer of an electronic device, a server of an electronic market, or a storage medium of a broadcasting server temporarily storing the software program.

As above, embodiments of the disclosure are described based on the various example embodiments of the disclosure and drawings. However, based on the descriptions, various modifications and alterations are possible for one of ordinary skill in the art. For example, even when the described techniques are performed in a different order from the described method, or the described components, such as the computer system or the module, etc., are integrated or combined in a different form from the described method or substituted or replaced by other components or equivalents, appropriate results may be achieved. It will also be understood that any of the embodiment(s) described herein may be used in conjunction with any other embodiment(s) described herein.

What is claimed is:

1. An electronic device comprising:
a display;
memory storing a program or at least one instruction; and
at least one processor, comprising processing circuitry,
wherein at least one processor, individually or collectively, is configured to execute the program or the at least one instruction stored in the memory and to cause the electronic device to:
obtain an input image;
obtain a first output image by performing scaling on the input image using first interpolation;
obtain a second output image by performing scaling on the input image using second interpolation different from the first interpolation; and
display, through the display, the first output image in at least one first frame from among a plurality of output frames and the second output image in at least one second frame, the at least one second frame being a remaining frame.

2. The electronic device of claim 1, wherein each of the first output image and the second output image comprises a plurality of pixels, and
gradation information included in any one first pixel from among the plurality of pixels included in the first output image is different from gradation information included in a second pixel from among the plurality of pixels included in the second output image, the second pixel corresponding to the first pixel.

3. The electronic device of claim 1, wherein a resolution of the first output image is the same as a resolution of the second output image as a first resolution, and
a resolution of the input image is a second resolution different from the first resolution.

4. The electronic device of claim 1, wherein the second interpolation comprises an algorithm set to scale a pixel comprising set first gradation information to a pixel comprising second gradation information differently set from the first gradation information.

5. The electronic device of claim 1, wherein the electronic device is further configured to:
identify, based on the first output image and the second output image, whether gradation information of any one third pixel from among the plurality of pixels included in the first output image is the same as gradation information of a fourth pixel from among the plurality of pixels included in the second output image, the fourth pixel corresponding to the third pixel;
based on identifying that the gradation information of the third pixel is the same as the gradation information of the fourth pixel, obtain a first corrected output image by correcting the second output image such that the gradation information of the fourth pixel included in the second output image becomes different from the gradation information of the third pixel included in the first output image; and
display, through the display, the first output image in the at least one first frame and the first corrected output image in the at least one second frame.

6. The electronic device of claim 1, wherein the electronic device is further configured to:
identify, based on the first output image and the second output image, whether gradation information of any one third pixel from among the plurality of pixels included in the first output image is the same as gradation information of a fourth pixel from among the plurality of pixels included in the second output image, the fourth pixel corresponding to the third pixel;
based on identifying that the gradation information of the third pixel is the same as the gradation information of the fourth pixel, obtain a second corrected output image by correcting the second output image such that a maximum luminance of the second output image is different from a maximum luminance of the first output image; and
display, through the display, the first output image in the at least one first frame and the second corrected output image in the at least one second frame.

7. The electronic device of claim 1, wherein a period of the at least one second frame among the plurality of output frames is set based on a characteristic of the display.

8. The electronic device of claim 1, wherein the electronic device is further configured to differently set, based on the input image, the period of the at least one second frame among the plurality of output frames.

9. The electronic device of claim 1, further comprising:
a first scaler configured to perform the first interpolation; and
a second scaler configured to perform the second interpolation,
wherein the electronic device is further configured to: obtain the first output image by performing scaling on the input image using the first scaler; and
obtain the second output image by performing scaling on the input image using the second scaler.

10. The electronic device of claim 1, further comprising a third scaler configured to perform at least one of the first interpolation or the second interpolation,
wherein the electronic device is further configured to obtain any one of the first output image or the second output image by performing, through the third scaler, scaling on the input image using any one interpolation, and
at least one processor, individually and/or collectively, is configured to execute the program or the at least one instruction stored in the memory and to cause the electronic device to obtain a remaining output image from the first output image or the second output image by performing scaling on the input image using a remaining interpolation method from the first interpolation or the second interpolation.

11. A method of operating an electronic device, the method comprising:
obtaining an input image;
obtaining a first output image by performing scaling on the input image using first interpolation;
obtaining a second output image by performing scaling on the input image using second interpolation different from the first interpolation; and
displaying, through a display, the first output image in at least one first frame from among a plurality of output frames and the second output image in at least one second frame, the second frame being a remaining frame.

12. The method of claim 11, wherein gradation information included in any one first pixel from among a plurality of pixels included in the first output image is different from gradation information included in a second pixel from among a plurality of pixels included in the second output image, the second pixel corresponding to the first pixel.

13. The method of claim 11, wherein a resolution of the first output image is the same as a resolution of the second output image as a first resolution, and
a resolution of the input image is a second resolution different from the first resolution.

14. The method of claim 11, wherein the second interpolation comprises an algorithm set to scale at least one pixel comprising set first gradation information to at least one pixel comprising second gradation information differently set from the first gradation information.

15. The method of claim 11, further comprising:
identifying, based on the first output image and the second output image, whether gradation information of any one third pixel from among the plurality of pixels included in the first output image is the same as gradation information of a fourth pixel from among the plurality of pixels included in the second output image, the fourth pixel corresponding to the third pixel;
based on identifying that the gradation information of the third pixel is the same as the gradation information of the fourth pixel, obtaining a first corrected output image by correcting the second output image such that the gradation information of the fourth pixel included in the second output image becomes different from the gradation information of the third pixel included in the first output image; and
displaying, through the display, the first output image in the at least one first frame and the first corrected output image in the at least one second frame.

16. The method of claim 11, further comprising:
identifying, based on the first output image and the second output image, whether gradation information of any one third pixel from among the plurality of pixels included in the first output image is the same as gradation information of a fourth pixel from among the plurality of pixels included in the second output image, the fourth pixel corresponding to the third pixel;
based on identifying that the gradation information of the third pixel is the same as the gradation information of the fourth pixel, obtaining a second corrected output image by correcting the second output image such that a maximum luminance of the second output image is different from a maximum luminance of the first output image; and
displaying, through the display, the first output image in the at least one first frame and the second corrected output image in the at least one second frame.

17. The method of claim 11, wherein a period of the at least one second frame among the plurality of output frames is set based on a characteristic of the display.

18. The method of claim 11, further comprising:
setting, based on the input image, the period of the at least one second frame among the plurality of output frames.

19. The method of claim 11, wherein the obtaining of the first output image comprises obtaining the first output image by performing scaling on the input image using a first scaler configured to perform the first interpolation, and
the obtaining of the second output image comprises obtaining the second output image by performing scaling on the input image using a second scaler configured to perform the second interpolation.

20. A non-transitory computer-readable recording medium having recorded thereon a program which, when executed by at least one processor, comprising processing circuitry, individually and/or collectively, of an electronic device, cause the electronic device to perform the method of claim 11.
